(19) United States
(12) Patent Application Publication
(10) Pub. No.: US 2025/0132803 A1
(43) Pub. Date: Apr. 24, 2025

(54) DATA PROCESSING METHOD AND APPARATUS, COMMUNICATION METHOD AND APPARATUS, AND TERMINAL DEVICE AND NETWORK DEVICE

(71) Applicant: GUANGDONG OPPO MOBILE TELECOMMUNICATIONS CORP., LTD., Dongguan (CN)

(72) Inventor: Han XIAO, Dongguan (CN)

(21) Appl. No.: 19/002,425

(22) Filed: Dec. 26, 2024

Related U.S. Application Data
(63) Continuation of application No. PCT/CN2022/105504, filed on Jul. 13, 2022.

(51) Int. Cl. H04B 7/06

(52) U.S. Cl. CPC H04B 7/0626; H04B 7/0634

(57) ABSTRACT

A data processing method includes: performing data augmentation on first channel state information (CSI) data based on feature information of the first CSI data, to obtain a plurality of pieces of second CSI data; where the feature information includes at least one of: a spatial-domain feature or a frequency-domain feature; and taking at least the first CSI data and the plurality of pieces of second CSI data as CSI sample data.

### CROSS-REFERENCE TO RELATED APPLICATION

This application is a Continuation Application of International Application No. PCT/CN2022/105504 filed on Jul. 13, 2022, which is incorporated herein by reference in its entirety.

### TECHNICAL FIELD

The present disclosure relates to the field of communications, and more particular, to a data processing method, a communication method and apparatus, a terminal device and a network device.

### BACKGROUND

Using a nonlinear fitting capability of neural network to compress and feed back channel state information can greatly improve compression efficiency and feedback accuracy. However, a prerequisite for implementing this scheme is that massive training data is required to support construction of a model, and there are certain challenges to collect such massive channel state information in terms of actual collection cost and difficulty of collection.

### SUMMARY

Embodiments of the present disclosure provide a data processing method, a communication method and apparatus, a terminal device and a network device.

The embodiments of the present disclosure provide a data processing method, and the method includes:
performing data augmentation on first channel state information (CSI) data based on feature information of the first CSI data, to obtain a plurality of pieces of second CSI data; where the feature information includes at least one of: a spatial-domain feature or a frequency-domain feature; and
taking at least the first CSI data and the plurality of pieces of second CSI data as CSI sample data.

The embodiments of the present disclosure provide a communication method, and the method includes:
transmitting, by a terminal device, first information, where the first information is obtained by inputting target channel state information (CSI) data into a first target model for performing encoding processing; and the first target model is obtained by performing model training on a first preset model based on CSI sample data obtained by the above method.

The embodiments of the present disclosure provide a communication method, and the method includes:
receiving, by a network device, first information; and inputting the first information into a second target model for performing decoding processing, to obtain target CSI data corresponding to the first information; where the second target model is obtained by performing model training on a second preset model based on CSI sample data obtained by the above method.

The embodiments of the present disclosure provide a data processing apparatus, and the data processing apparatus includes:
a data augmentation processing unit, configured to perform data augmentation on first channel state information (CSI) data based on feature information of the first CSI data, to obtain a plurality of pieces of second CSI data; where the feature information includes at least one of: a spatial-domain feature or a frequency-domain feature; and
a sample data determining unit, configured to take at least the first CSI data and the plurality of pieces of second CSI data as CSI sample data.

The embodiments of the present disclosure provide a terminal device, and the terminal device includes:
a transmitting unit, configured to transmit first information, where the first information is obtained by inputting target channel state information (CSI) data into a first target model for performing encoding processing; and the first target model is obtained by performing model training on a first preset model based on CSI sample data obtained by the above method.

The embodiments of the present disclosure provide a network device, and the network device includes:
a receiving unit, configured to receive first information; and input the first information into a second target model for performing decoding processing, to target obtain CSI data corresponding to the first information; where the second target model is obtained by performing model training on a second preset model based on CSI sample data obtained by the above method.

The embodiments of the present disclosure provide a terminal device, and the terminal device includes a processor and a memory. The memory is configured to store a computer program, and the processor is configured to call the computer program stored in the memory and run the computer program, to cause the terminal device to perform the above communication method applied to a terminal device side.

The embodiments of the present disclosure provide a network device, and the network device includes a processor and a memory. The memory is configured to store a computer program, and the processor is configured to call the computer program stored in the memory and run the computer program, to cause the network device to perform the above communication method applied to a network device side.

The embodiments of the present disclosure provide a chip, configured to implement the above data processing method or communication methods.

Exemplarily, the chip includes a processor, and the processer is configured to call a computer program from a memory and run the computer program, to cause a device equipped with the chip to perform the above data processing method or communication methods.

The embodiments of the present disclosure provide a computer-readable storage medium, configured to store a computer program. The computer program, when run by a device, causes the device to perform the above data processing method or communication methods.

The embodiments of the present disclosure provide a computer program product, which includes computer program instructions. The computer program instructions cause a computer to perform the above data processing method or communication methods.

The embodiments of the present disclosure provide a computer program. The computer program, when run on a computer, causes the computer to perform the above data processing method or communication methods.

### BRIEF DESCRIPTION OF THE DRAWINGS

FIG. 1 is a schematic diagram of an application scenario in accordance with an embodiment of the present disclosure.

FIG. 2 is a schematic diagram of a neuron structure in accordance with an embodiment of the present disclosure.

FIG. 3 is a schematic diagram of a feedback system for channel state information in accordance with another embodiment of the present disclosure.

FIG. 4 is a schematic flowchart of a data processing method 400 in accordance with an embodiment of the present disclosure.

FIG. 5 is a schematic flowchart of a communication method 500 in accordance with an embodiment of the present disclosure.

FIG. 6 is a schematic flowchart of a communication method 600 in accordance with an embodiment of the present disclosure.

FIG. 7 is a schematic diagram of a first discrete Fourier transform (DFT) vector space in accordance with an embodiment of the present disclosure.

FIG. 8 is a first schematic block diagram of a data processing apparatus 800 in accordance with an embodiment of the present disclosure.

FIG. 9 is a second schematic block diagram of a data processing apparatus 800 in accordance with an embodiment of the present disclosure.

FIG. 10 is a schematic block diagram of a terminal device 1000 in accordance with an embodiment of the present disclosure.

FIG. 11 is a schematic block diagram of a network device 1100 in accordance with an embodiment of the present disclosure.

FIG. 12 is a schematic block diagram of a communication device 1200 in accordance with embodiments of the present disclosure.

FIG. 13 is a schematic block diagram of a chip 1300 in accordance with embodiments of the present disclosure.

FIG. 14 is a schematic block diagram of a communication system 1400 in accordance with embodiments of the present disclosure.

### DETAILED DESCRIPTION

Technical solutions in the embodiments of the present disclosure will be described below with reference to the accompanying drawings in the embodiments of the present disclosure.

The technical solutions in the embodiments of the present disclosure may be applied to various communication systems, such as, a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial communication network (Non-Terrestrial Network, NTN) system, a universal mobile telecommunication system (UMTS), a wireless local area network (WLAN), wireless fidelity (WiFi), a fifth-generation communication (5th-Generation, 5G) system, or other communication systems.

Generally speaking, traditional communication systems support a limited number of connections which are easy to be implemented. However, with development of communication technologies, mobile communication systems will support not only the traditional communication, but also, for example, device to device (D2D) communication, machine to machine (M2M) communication, machine type communication (MTC), vehicle to vehicle (V2V) communication, or vehicle to everything (V2X) communication. The embodiments of the present disclosure may also be applied to these communication systems.

In an implementation, a communication system in the embodiments of the present disclosure may be applied to a carrier aggregation (CA) scenario, may also be applied to a dual connectivity (DC) scenario, or may also be applied to a standalone (SA) networking scenario.

In an implementation, the communication system in the embodiments of the present disclosure may be applied to an unlicensed spectrum, where the unlicensed spectrum may also be considered as a shared spectrum; alternatively, the communication system in the embodiments of the present disclosure may also be applied to a licensed spectrum, where the licensed spectrum may also be considered as an unshared spectrum.

In the embodiments of the present disclosure, each embodiment will be described in conjunction with a network device and a terminal device. The terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, a user device, or the like.

The terminal device may be a station (STATION, ST) in the WLAN, which may be a cellular phone, a cordless phone, a session initiation protocol (SIP) phone, a wireless local loop (WLL) station, a personal digital assistant (PDA) device, a handheld device with wireless communication functions, a computing device or other processing devices connected to a wireless modem, an in-vehicle device, a wearable device, a terminal device in a next-generation communication system (e.g., an NR network), a terminal device in a future evolved public land mobile network (PLMN) network, or the like.

In the embodiments of the present disclosure, the terminal device may be deployed on land, including indoor or outdoor, handheld, wearable, or in-vehicle. The terminal device may also be deployed on water (e.g., on a steamship); and the terminal device may also be deployed in air (e.g., on an airplane, on a balloon, or on a satellite).

In the embodiments of the present disclosure, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like.

As an example but not a limitation, in the embodiments of the present disclosure, the terminal device may also be a wearable device. The wearable device may also be referred to as a wearable smart device, which is a generic term for a wearable device by using wearable technology and intelligent design for everyday wear, such as glasses, gloves, a watch, clothing, or shoes. The wearable device is a portable device that is worn directly on a body, or integrated into a user's clothing or accessories. The wearable device is not only a hardware device, but also achieves powerful functions through software supporting as well as data interaction or cloud interaction. Generalized wearable smart devices includes full-featured, large-sized devices that may implement full or partial functionality without relying on smart phones, such as a smart watch or smart glasses, and devices that focus on a certain type of application functionality only and need to be used in conjunction with other devices (such as smart phones), such as various smart bracelets or smart jewelries for monitoring physical signs.

In the embodiments of the present disclosure, the network device may be a device used for communicating with a mobile device The network device may be an access point (AP) in the WLAN, a base station (Base Transceiver Station, BTS) in the GSM or CDMA, a base station (NodeB, NB) in the WCDMA, an evolutional base station (Evolutional Node B, eNB or eNodeB) in the LTE, a relay station or an access point, an in-vehicle device, a wearable device, a network device (gNB) in an NR network, a network device in a future evolved PLMN, a network device in an NTN, or the like.

As an example but not a limitation, in the embodiments of the present disclosure, the network device may have a mobile characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may also be a base station set up on land, water, or the like.

In the embodiments of the present disclosure, the network device may provide services for a cell, and the terminal device may communicate with the network device through transmission resources (e.g., frequency domain resources, or frequency spectrum resources) used by the cell. The cell may be a cell corresponding to the network device (such as the base station). The cell may belong to a macro base station or a base station corresponding to a small cell. The small cell here may include a metro cell, a micro cell, a pico cell, a femto cell, or the like. These small cells have characteristics of small coverage and low transmission power, which are applicable for providing a data transmission service with high speed.

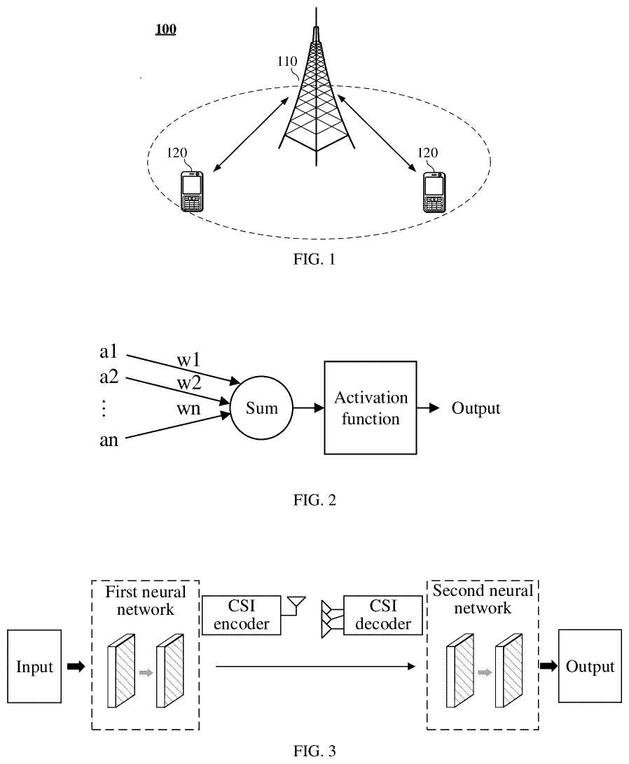

FIG. 1 exemplarily illustrates a communication system 100. The communication system includes a network device 110 and two terminal devices 120. In an implementation, the communication system 100 may include a plurality of network devices 110, and coverage range of each network device 110 may be provided therein with other number of terminal devices, which is not limited in the embodiments of the present disclosure.

In an implementation, the communication system 100 may further include other network entities, such as a mobility management entity (MME), an access and mobility management function (AMF) entity, which are not limited in the embodiments of the present disclosure.

The network device may include an access network device and a core network device. That is, the wireless communication system further includes a plurality of core networks for communicating with the access network device. The access network device may be an evolutional base station (evolutional node B, abbreviated as eNB or e-NodeB), a macro base station, a micro base station (also referred to as a “small base station”), a pico base station, an access point (AP), a transmission point (TP) or a new generation Node B (gNodeB) in a long-term evolution (LTE) system, a next generation (mobile communication system) (next radio, NR) system or an authorized auxiliary access long-term evolution (LAA-LTE) system.

It should be understood that a device in a network/system having communication functions in the embodiments of the present disclosure may be referred to as a communication device. In an example of the communication system illustrated in FIG. 1, the communication devices may include a network device and a terminal device that have the communication functions. The network device and the terminal devices may be specific devices in the embodiments of the present disclosure, which will not be repeated herein. The communication devices may further include other devices in the communication system, such as network controllers, mobility management entities or other network entities, which are not limited in the embodiments of the present disclosure.

It should be understood that, the terms “system” and “network” are often used interchangeably herein. The term “and/or” herein is only an association relationship to describe associated objects, meaning that there may be three relationships between associated objects, for example, “A and/or B” may represent: A exists alone, both A and B exist, and B exists alone. In addition, a character “/” herein generally means that related objects before and after this character are in an “or” relationship.

It should be understood that, “indicate” mentioned in the embodiments of the present disclosure may mean a direct indication or an indirect indication, or represent that there is an association relationship. For example, A indicates B, which may mean that A directly indicates B, for example, B may be obtained through A; or it may mean that A indirectly indicates B, for example, A indicates C, and B may be obtained through C; or it may mean that there is an association relationship between A and B.

In the description of the embodiments of the present disclosure, the term “correspond” may mean that there is a direct correspondence or indirect correspondence between the two, or it may mean that there is an associated relationship between the two, or it may mean a relationship of indicating and being indicated, or configuring and being configured, or the like.

To facilitate understanding of the technical solutions of the embodiments of the present disclosure, related technologies of the embodiments of the present disclosure are described in detail below. The following related technologies, as optional solutions, may be arbitrarily combined with the technical solutions of the embodiments of the present disclosure, and those combined solutions all belong to the protection scope of the embodiments of the present disclosure.

### I. CSI Data Feedback Based on Codebook

For 5G New Radio (NR) systems, in channel state information (i.e., CSI data) feedback design, a codebook-based scheme may be used to realize extraction and feedback of channel features. That is, after a transmitting end performs channel estimation, and obtains a corresponding precoding matrix according to channel estimation result, the transmitting end selects a coding matrix that best matches the precoding matrix from preset codebook according to a certain optimization criterion, and feeds back related information such as an index of the coding matrix that best matches the precoding matrix to a receiving end through a feedback link of an air interface, to enable the receiving end to implement precoding. Here, the codebook may be divided into three schemes: TypeI, TypeII, and eTypeII.

### II. Neural Network

Neural network is an operational model consisting of a plurality of neuron nodes connected to each other, where connections between nodes represents weighted values from an input signal to an output signal, called weights (such as w1 to wn). As shown in FIG. 2, each node performs weighted summing on different input signals (such as a1 to an) and outputs the sum through a specific activation function. Here, in the practical applications, the neural network may be specifically a fully connected neural network, a convolutional neural network, a recurrent neural network, or the like.

### III. CSI Data Feedback Based on Artificial Intelligence (AI)

Given great success of AI technology in computer vision, natural language processing and other fields, a field of communications has begun to try to seek new technical ideas (such as deep learning) using the AI technology, to solve technical problems that are limited by traditional methods. A neural network architecture commonly used in the deep learning is nonlinear and data-driven, which may perform feature extraction on actual channel state information and restore channel state information that is compressed and fed back at a UE side as much as possible at a base station side. As such, while ensuring restoration of the channel state information, possibility of reducing the CSI data feedback overhead at the UE side is provided.

As shown in FIG. 3, a feedback system for channel state information feedback system may be divided into two parts: an encoder (such as a CSI encoder) and a decoder (such as a CSI decoder), and the two parts are deployed at the UE side and base station (BS) side, respectively. After obtaining the channel state information through channel estimation, the UE side compresses and encodes a matrix of the channel state information through neural network of the encoder, and feeds back a compressed bit stream (that is, compressed CSI data) to the BS side through an air interface feedback link. The BS side recovers or reconstructs channel state information according to the feedback bit stream through the decoder to obtain the complete channel state information fed back. The structure shown in FIG. 3 may be used to perform encoding using several fully connected layers at an encoder side, and accordingly, the structure may be used to perform decoding using a convolutional neural network structure at a decoder side.

It is to be understood that internal model structures of the encoder and decoder may be flexibly designed using other models when the encoding and decoding framework remains unchanged, which are not specifically limited by solutions of the present disclosure.

### IV. Data Augmentation

Existing data augmentation schemes in the field of computer vision mainly perform operations such as flipping, rotating, cropping and scaling on image data, to augment a small amount of image data into a large amount of data. It is worth noting that in the above schemes, the image are not distorted in meaning due to corresponding operations, that is, content presented by itself is still retained in the generated data.

Here, using a nonlinear fitting capability of neural network to compress and feed back channel state information can greatly improve compression efficiency and feedback accuracy. However, a prerequisite for implementing this scheme is that massive training data is required to support construction of a model, and there are certain challenges to collect such massive channel state information in terms of actual collection cost and difficulty of collection.

Moreover, the existing data augmentation schemes for the image data in the field of computer vision are not suitable for the CSI data. Because the matrix of the CSI data is different from the image matrix, the matrix of the CSI data includes features such as spatial domain and frequency domain in the communication field, and performing the operations such as flipping, rotating, cropping and scaling on the CSI data like images would affect or even erase physical meaning information within the CSI data. Therefore, even though a large amount of data may be generated, training of an AI-based CSI data feedback model cannot be supported.

Based on this, the solutions of the present disclosure provide a method for performing data augmentation based on a small amount of data, so as to solve the problem that a small amount of existing samples cannot support the training of the AI-based CSI data feedback model.

The embodiments of the present disclosure provide a data processing method, and the method includes:
performing data augmentation on first channel state information (CSI) data based on feature information of the first CSI data, to obtain a plurality of pieces of second CSI data; where the feature information includes at least one of: a spatial-domain feature or a frequency-domain feature; and
taking at least the first CSI data and the plurality of pieces of second CSI data as CSI sample data.

In some embodiments, the method further includes:
determining a first basis vector set representing the spatial-domain feature of the first CSI data based on a first discrete Fourier transform (DFT) vector space constructed by a preset codebook;
where performing data augmentation on the first CSI data based on the feature information of the first CSI data, to obtain the plurality of pieces of second CSI data includes:
performing data augmentation on the first CSI data at least based on the first basis vector set representing the spatial-domain feature of the first CSI data, to obtain the plurality of pieces of second CSI data.

In some embodiments, where determining the first basis vector set representing the spatial-domain feature of the first CSI data based on the first DFT vector space constructed by the preset codebook includes:
selecting L orthogonal basis vectors from orthogonal basis vector sets included in the first DFT vector space, where correlation between the L orthogonal basis vectors and the spatial-domain feature of the first CSI data meets a first preset condition, L being a natural number greater than or equal to 1; and
obtaining the first basis vector set based on the selected L orthogonal basis vectors.

In some embodiments, the method further includes:
selecting, from a plurality of orthogonal basis vector sets included in the first DFT vector space, a target orthogonal basis vector set whose correlation with the spatial-domain feature of the first CSI data meets a second preset condition;
where selecting the L orthogonal basis vectors from the orthogonal basis vector set included in the first DFT vector space includes:
selecting the L orthogonal basis vectors from the target orthogonal basis vector set.

In some embodiments, where selecting, from the plurality of orthogonal basis vector sets included in the first DFT vector space, the target orthogonal basis vector set whose correlation with the spatial-domain feature of the first CSI data meets the second preset condition includes:
projecting the first CSI data into a vector space spanned by a diagonal block matrix, to obtain a first projection information matrix corresponding to each orthogonal basis vector set, where the diagonal block matrix is obtained based on the orthogonal basis vector sets included in the first DFT vector space, and elements in the first projection information matrix represent relevant information of projection coefficients after the spatial-domain feature of the first CSI data is projected into the diagonal block matrix; and
selecting, from the plurality of orthogonal basis vector sets, the target orthogonal basis vector set whose correlation with the spatial-domain feature of the first CSI data meets the second preset condition based on the first projection information matrix corresponding to each orthogonal basis vector set.

In some embodiments, the method further includes:
performing data processing on the elements in the first projection information matrix, to obtain a first vector corresponding to the orthogonal basis vector set, where the first vector represents total relevant information of projection coefficients corresponding to the frequency-domain feature of the first CSI data;
performing data processing on a part of elements in the first vector and another part of elements in the first vector, to obtain a second vector corresponding to the orthogonal basis vector set, where the second vector represents total relevant information of projection coefficients corresponding to the spatial-domain feature of the first CSI data; and
selecting, from the second vector, L first target elements corresponding to the orthogonal basis vector set;
where selecting, from the plurality of orthogonal basis vector sets, the target orthogonal basis vector set whose correlation with the spatial-domain feature of the first CSI data meets the second preset condition based on the first projection information matrix corresponding to each orthogonal basis vector set includes:
selecting, from the plurality of orthogonal basis vector sets, the target orthogonal basis vector set based on L first target elements corresponding to each orthogonal basis vector set.

In some embodiments, where selecting, from the plurality of orthogonal basis vector sets, the target orthogonal basis vector set based on the L first target elements corresponding to each orthogonal basis vector set includes:
obtaining a respective target sum corresponding to each orthogonal basis vector set based on the L first target elements corresponding to each orthogonal basis vector set;
selecting a target value from a plurality of target sums; and
taking an orthogonal basis vector set corresponding to the selected target value as the target orthogonal basis vector set.

In some embodiments, the method further includes:
determining a second basis vector set representing at least the frequency-domain feature of the first CSI data based on a second DFT vector space constructed by the preset codebook and the first basis vector set representing the spatial-domain feature of the first CSI data;
where performing data augmentation on the first CSI data at least based on the first basis vector set representing the spatial-domain feature of the first CSI data, to obtain the plurality of pieces of second CSI data includes:
performing data augmentation on the first CSI data based on the first basis vector set and the second basis vector set, to obtain the plurality of pieces of second CSI data.

In some embodiments, where determining the second basis vector set representing at least the frequency-domain feature of the first CSI data based on the second DFT vector space constructed by the preset codebook and the first basis vector set representing the spatial-domain feature of the first CSI data includes:
projecting the first CSI data into a space spanned by the first basis vector set, to obtain a first projection coefficient matrix; where elements in the first projection coefficient matrix represent projection coefficients of the spatial-domain feature of the first CSI data in the space spanned by the first basis vector set;
selecting, from orthogonal basis vectors included in the second DFT vector space constructed by the preset codebook, M orthogonal basis vectors based on the first projection coefficient matrix, where correlation between the M orthogonal basis vectors and projection coefficients corresponding to the frequency-domain feature of the first CSI data in the first projection coefficient matrix meets a third preset condition, M being a natural number greater than or equal to 1; and
obtaining the second basis vector set based on the selected M orthogonal basis vectors.

In some embodiments, where projecting the first CSI data into the space spanned by the first basis vector set includes:
projecting the first CSI data into a space spanned by a first basis vector matrix, where the first basis vector matrix is a diagonal block matrix constructed based on the first basis vector set.

In some embodiments, the method further includes:
projecting the first projection coefficient matrix into a space spanned by orthogonal basis vectors of the second DFT vector space, to obtain a second projection information matrix;
where elements in the second projection information matrix represent relevant information of projection coefficients of the frequency-domain feature of the first CSI data corresponding to the first projection coefficient matrix in the space spanned by the orthogonal basis vectors of the second DFT vector space;
where selecting, from the orthogonal basis vectors included in the second DFT vector space constructed by the preset codebook, the M orthogonal basis vectors based on the first projection coefficient matrix includes:
selecting, from the orthogonal basis vectors included in the second DFT vector space, the M orthogonal basis vectors based on the second projection information matrix.

In some embodiments, where selecting, from the orthogonal basis vectors included in the second DFT vector space, the M orthogonal basis vectors based on the second projection information matrix includes:
performing data processing on the elements in the second projection information matrix, to obtain a third vector, where the third vector represents total relevant information of the projection coefficients corresponding to the frequency-domain feature of the first CSI data;
selecting M second target elements from the third vector; and
selecting, from the second DFT vector space, orthogonal basis vectors corresponding to the M second target elements, to obtain the M orthogonal basis vectors.

In some embodiments, the method further includes:
projecting the first projection coefficient matrix into a space spanned by the second basis vector set, to obtain a second projection coefficient matrix, where elements in the second projection coefficient matrix represent projection coefficients of the projection coefficients of the spatial-domain feature of the first CSI data in the space spanned by the first basis vector set, in the space spanned by the second basis vector set;
where performing data augmentation on the first CSI data based on the first basis vector set and the second basis vector set, to obtain the plurality of pieces of second CSI data includes:
obtaining the plurality of pieces of second CSI data based on the second projection coefficient matrix, a first basis vector matrix and a second basis vector matrix; where the first basis vector matrix is a matrix formed based on the first basis vector set, and the second basis vector matrix is a matrix formed based on the second basis vector set.

In some embodiments, the method further includes:
performing phase adjustment and/or amplitude adjustment on each of the elements in the second projection coefficient matrix, to obtain a plurality of third projection coefficient matrices;
where obtaining the plurality of pieces of second CSI data based on the second projection coefficient matrix, the first basis vector matrix and the second basis vector matrix includes:
obtaining the plurality of pieces of second CSI data based on the plurality of third projection coefficient matrices, the first basis vector matrix and the second basis vector matrix.

In some embodiments, where obtaining the plurality of pieces of second CSI data based on the plurality of third projection coefficient matrices, the first basis vector matrix and the second basis vector matrix includes:
obtaining a plurality of vectors to be processed based on a matrix product of the third projection coefficient matrices, the first basis vector matrix and the second basis vector matrix; and
performing normalization processing on the plurality of vectors to be processed, to obtain the plurality of pieces of second CSI data.

In some embodiments, where performing phase adjustment and/or amplitude adjustment on each of the elements in the second projection coefficient matrix includes:
taking each of the elements in the second projection coefficient matrix as a center, and adjusting the center in terms of phase and/or amplitude.

In some embodiments, the method further includes:
obtaining a target autocorrelation matrix of the first CSI data, where the target autocorrelation matrix represents the spatial-domain feature and the frequency-domain feature of the first CSI data; and
performing singular value decomposition on the target autocorrelation matrix, to obtain a singular value decomposition result, where the singular value decomposition result includes a singular vector matrix representing the spatial-domain feature and the frequency-domain feature of the first CSI data and a singular value matrix;
where performing data augmentation on the first CSI data based on the feature information of the first CSI data, to obtain the plurality of pieces of second CSI data includes:
performing, by using a constructed target random matrix, processing on the singular value decomposition result, to obtain the plurality of pieces of second CSI data after data augmentation.

In some embodiments, the method further includes:
obtaining a first autocorrelation matrix of the first CSI data, where the first autocorrelation matrix represents the spatial-domain feature of the first CSI data; and
obtaining a second autocorrelation matrix of the first CSI data, where the second autocorrelation matrix represents the frequency-domain feature of the first CSI data;
where obtaining the target autocorrelation matrix of the first CSI data includes:
obtaining the target autocorrelation matrix based on the first autocorrelation matrix and the second autocorrelation matrix.

In some embodiments, where performing, by using the target random matrix, processing on the singular value decomposition result, to obtain the plurality of pieces of second CSI data after data augmentation includes:
replacing a first matrix in the singular vector matrix by using the target random matrix; and
performing matrix product processing on the target random matrix, a second matrix in the singular vector matrix and the singular value matrix, to obtain the plurality of pieces of second CSI data; where the target autocorrelation matrix is a symmetric matrix, and the first matrix and the second matrix meet a symmetric relationship.

In some embodiments, where performing the matrix product processing on the target random matrix, the second matrix in the singular vector matrix and the singular value matrix, to obtain the plurality of pieces of second CSI data includes:
performing matrix product processing on the target random matrix, the second matrix in the singular vector matrix and the singular value matrix, to obtain an augmented data matrix; and
arranging the augmented data matrix based on vector dimensions of the first CSI data, to obtain the plurality of pieces of second CSI data after data augmentation.

In some embodiments, where arranging the augmented data matrix based on the vector dimensions of the first CSI data, to obtain the plurality of pieces of second CSI data after data augmentation includes:
arranging the augmented data matrix based on the vector dimensions of the first CSI data, to obtain an arranged augmented data matrix; and
performing normalization processing on the arranged augmented data matrix, to obtain the plurality of pieces of second CSI data.

In some embodiments, the method further includes:
performing, based on the CSI sample data, model training on a first preset model, to obtain a first target model, where the first target model is used to preform encoding processing on channel state information (CSI) data to obtain target CSI data; and/or
performing, based on the CSI sample data, model training on a second preset model, to obtain a second target model, where the second target model is used to preform decoding processing on the target CSI data to obtain CSI corresponding to the target CSI data.

The embodiments of the present disclosure provide a communication method, and the method includes:
transmitting, by a terminal device, first information, where the first information is obtained by inputting channel state information (CSI) data into a first target model for performing encoding processing; and the first target model is obtained by performing model training on a first preset model based on CSI sample data obtained by the above data processing method.

The embodiments of the present disclosure provide a communication method, and the method includes:
receiving, by a network device, first information; and
inputting the first information into a second target model for performing decoding processing, to obtain CSI data corresponding to the first information; where the second target model is obtained by performing model training on a second preset model based on CSI sample data obtained by the above data processing method.

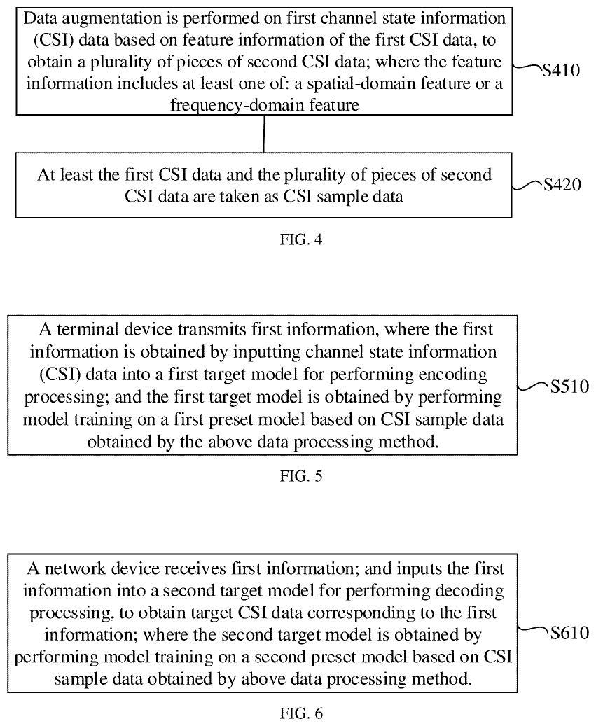

Exemplarily, FIG. 4 is a schematic flowchart of a data processing method 400 in accordance with an embodiment of the present disclosure. Optionally, the method may be applied to the system shown in FIG. 1, but is not limited thereto. The method includes at least part of the following contents.

S410, data augmentation is performed on first channel state information (CSI) data based on feature information of the first CSI data, to obtain a plurality of pieces of second CSI data; where the feature information includes at least one of: a spatial-domain feature or a frequency-domain feature.

S420, at least the first CSI data and the plurality of pieces of second CSI data are taken as CSI sample data.

It can be understood that the data processing method in the solutions of the present disclosure may be performed in any entity in the system shown in FIG. 1, or in other electronic devices with computing capabilities (such as, personal computers, servers, server clusters or the like) other than the system shown in FIG. 1, which are not limited by the solutions of the present disclosure.

In an implementation, the first CSI data is CSI data estimated by the terminal device, and may also be referred to as real CSI data. Accordingly, the second CSI data is CSI data obtained after data augmentation is performed on the real CSI data.

In this way, since the second CSI data is obtained after data augmentation is performed on the first CSI data based on the spatial-domain feature and/or frequency-domain feature of the first CSI data, the second CSI data may effectively retain communication physical characteristics of original CSI data (that is, the first CSI data). Therefore, training data is provided for model training of the AI-based CSI data feedback model, the problem that a small amount of real data cannot support model training is solved effectively, and a foundation for improving accuracy of prediction results of the AI-based CSI data feedback model is also laid.

In a specific example of the solutions of the present disclosure, after obtaining the CSI sample data, model training may be performed on the AI-based CSI data feedback model based on the CSI sample data. Exemplarily, the method further includes at least one of following trainings.

Training I: training is performed on a preset model for encoding processing at a transmitting end (such as terminal device side). Exemplarily, model training is performed on a first preset model based on the CSI sample data, to obtain a first target model, where the first target model is used to preform encoding processing on channel state information (CSI) data to obtain target CSI data.

Training II: training is performed on a preset model for decoding processing at a receiving end (such as base station side). Exemplarily, model training is performed on a second preset model based on the CSI sample data, to obtain a second target model, where the second target model is used to preform decoding processing on the target CSI data to obtain CSI corresponding to the target CSI data.

The above trainings I and II may be performed by selecting one or the other, or both of them may be performed, which is not limited by the solutions of the present disclosure. Moreover, the solutions of the present disclosure does not limit execution orders of the above two kinds of trainings, for example, training at the same time, or training alone, or training one model after training on the other model is completed, or the like. As long as the model is trained by using the CSI sample data of the solutions of the present disclosure, they are all within the protection scope of the solutions of the present disclosure.

In an example, the first target model and the second target model are different templates in the AI-based CSI data feedback model. For example, the first target model is a sub-model for encoding processing in the AI-based CSI data feedback model; and accordingly, the first target model is a sub-model for decoding processing in the AI-based CSI data feedback model. Further, as shown in FIG. 3, the first target model may be specifically located in an encoder at the terminal device side; and accordingly, the second target model may be specifically located in a decoder at the base station side. In an example, in this scenario, the above two kinds of training may be performed jointly, or, after training on one model is completed, the trained model is used to train the other model. For example, after training on the first preset model is completed to obtain the first target model, the first target model (such as output results of the first target model) is used to perform training on the second preset model, thereby effectively improving the accuracy of model prediction.

Here, in a scenario where model training is performed on the second target model based on the output results of the first target model, the operation that model training is performed on the second preset model based on the CSI sample data may be understood as: model training is performed on the second target model indirectly based on the CSI sample data. It is to be noted that whether the CSI sample data obtained by the solutions of the present disclosure is directly used to preform model training (such as the CSI sample data is directly taken as input of a model to be trained) or the CSI sample data obtained by the solutions of the present disclosure is indirectly used to preform model training (such as data obtained after processing the CSI sample data is taken as the input of the model to be trained), both fall into the scope of “the operation that model training is performed on the first preset model or second preset model based on the CSI sample data”, that is, both are within the protection scope of the solutions of the present disclosure.

In this way, since model training may be performed accordingly based on the CSI sample data obtained by the solutions of the present disclosure, the problem that a small amount of the real data cannot support model training is solved effectively, costs of manpower, material and the like for obtaining the real data are greatly reduced, and also the foundation for improving the accuracy of prediction results of the AI-based CSI data feedback model is also laid.

It is to be noted that, from an experimental perspective, there is no overfitting phenomenon when model training is performed based on the sample data of solutions of the present disclosure, and the obtained model has a better performance.

The solutions of the present disclosure provide two schemes for performing data augmentation on the first CSI data. Each of the two schemes is specifically described in detail below.

A first data augmentation scheme: data augmentation is performed on the first CSI data, such as the real CSI data, by means of codebook, and details are as follows.

In a specific example of the solutions of the present disclosure, data augmentation of the first CSI data may be implemented based on a first basis vector set. Exemplarily, the method further includes:
determining the first basis vector set representing the spatial-domain feature of the first CSI data based on a first discrete Fourier transform (DFT) vector space constructed by a preset codebook;
Based on this, the operation S410 specifically includes: performing data augmentation on the first CSI data at least based on the first basis vector set representing the spatial-domain feature of the first CSI data, to obtain the plurality of pieces of second CSI data.

In the practical applications, the first CSI data may be represented by a matrix, for example, the matrix WϵC^{Nt×Nsb}, where C represents a complex space, Nt represents the number of ports of transmitting antennas, and Nsb represents the number of frequency domain sub-bands corresponding to a transmitting end. Therefore, the spatial-domain feature of the first CSI data is quantitatively expressed based on the matrix W, which provides supports for effectively extracting communication physical characteristics of the first CSI data and realizing data augmentation. In addition, this scheme is simple and highly interpretable. Here, it may be understood that the above is only an example of matrix expression. In the actual applications, rows and columns of the matrix may also be adjusted based on demands, and the solutions of the present disclosure do not limit specific expression forms of the matrix.

Here, since the first basis vector set may represent the spatial-domain feature of the first CSI data, the second CSI data obtained after data augmentation is perform based on the first basis vector set may at least represent the original CSI data, that is, the spatial-domain feature of the first CSI data. Compared with existing schemes of image data, the data augmentation scheme of the solutions of the present disclosure may effectively retain physical meaning information within the original CSI data, which provides data support for subsequent model training and also lays the foundation for improving the accuracy of the model training results.

In a specific example, the preset codebook may be any one of the three schemes of TypeI, TypeII, and eTypeII, and the solutions of the present disclosure are not limited thereto. As long as the DFT space vectors may be constructed based on the preset codebook, all of them are within the protection scope of the solutions of the present disclosure. Further, the solutions of the present disclosure do not specifically limit the schemes of constructing the first DFT vector space based on the preset codebook. The following specific example provides a method for constructing the first DFT vector space based on eTypeII, which may refer to following description and will not be repeated here. It may be understood that the scheme is only an example and is not intended to limit the solutions of the present disclosure.

In a specific example of the solutions of the present disclosure, the first basis vector set may be obtained by using the following scheme. Exemplarily, the above operation of determining the first basis vector set representing the spatial-domain feature of the first CSI data based on the first DFT vector space constructed by the preset codebook specifically includes:
selecting L orthogonal basis vectors from orthogonal basis vector sets included in the first DFT vector space, where correlation between the L orthogonal basis vectors and the spatial-domain feature of the first CSI data meets a first preset condition (for example, the L orthogonal basis vectors are L vectors selected from the first DFT vector space and have the highest correlation with the spatial-domain feature of the first CSI data), and L is a natural number greater than or equal to 1; and obtaining the first basis vector set based on the selected L orthogonal basis vectors; that is, the L orthogonal basis vectors constitute the first basis vector set.

It may be understood that magnitude of the correlation may be measured by similarity between vectors. Further, L is a natural number greater than or equal to 1 and less than dimensions of the spatial-domain feature of the first CSI data. For example, in the matrix WϵC^{Nt×Nsb} of the first CSI data, L is a natural number greater than or equal to 1 and less than Nt/2.

Further, in an example, average correlation may also be used as an indicator to select the L orthogonal basis vectors from the first DFT vector space. In this case, the L orthogonal basis vectors may also be specifically L vectors selected from the first DFT vector space and have the highest average correlation with the spatial-domain feature of the first CSI data.

It is to be noted that, in the actual applications, the first preset condition may be set based on actual demand, which is not specifically limited by solutions of the present disclosure.

Furthermore, in a specific example of the solutions of the present disclosure, a target orthogonal basis vector set may be selected from a plurality of orthogonal basis vector sets included in the first DFT vector space firstly, and then the L orthogonal basis vectors may be selected from the target orthogonal basis vector set. Exemplarily, the method further includes:
selecting, from the plurality of orthogonal basis vector sets included in the first DFT vector space, a target orthogonal basis vector set whose correlation with the spatial-domain feature of the first CSI data meets a second preset condition (for example, selecting one set having the highest correlation as the target orthogonal basis vector set).

Based on this, the above operation of selecting the L orthogonal basis vectors from the orthogonal basis vector sets included in the first DFT vector space specifically includes: selecting the L orthogonal basis vectors from the target orthogonal basis vector set.

It may be understood that the correlation in the example may also be specifically the average correlation. In this case, the target orthogonal basis vector set may be specifically as: one set having the highest average correlation with the spatial-domain feature of the first CSI data is selected from the plurality of orthogonal basis vector sets included in the first DFT vector space, and then the set having the highest average correlation with the spatial-domain feature of the first CSI data is taken as the target orthogonal basis vector set.

It should be noted that, in the actual applications, the second preset condition may be set based on actual demand, which is not specifically limited by solutions of the present disclosure.

In a specific example of the solutions of the present disclosure, the target orthogonal basis vector set may be selected from the plurality of orthogonal basis vector sets included in the first DFT vector space by using the following scheme; that is, the above operation of selecting, from the plurality of orthogonal basis vector sets included in the first DFT vector space, the target orthogonal basis vector set whose correlation with the spatial-domain feature of the first CSI data meets the second preset condition specifically includes:
projecting the first CSI data (e.g., the matrix of the first CSI data) into a vector space spanned by a diagonal block matrix, to obtain a first projection information matrix corresponding to each orthogonal basis vector set, where the diagonal block matrix is obtained based on the orthogonal basis vector sets included in the first DFT vector space, and elements in the first projection information matrix represent relevant information of projection coefficients after the spatial-domain feature of the first CSI data is projected into the diagonal block matrix; and
selecting, from the plurality of orthogonal basis vector sets, the target orthogonal basis vector set whose correlation with the spatial-domain feature of the first CSI data meets the second preset condition based on the first projection information matrix corresponding to each orthogonal basis vector set.

It may be understood that, each orthogonal basis vector set corresponds to one diagonal block matrix, and accordingly, one first projection information matrix may also be obtained based on the above scheme. In this way, the first projection information matrix corresponding to each orthogonal basis vector set may be obtained, and then, based on the first projection information matrix corresponding to each orthogonal basis vector set, the target orthogonal basis vector set may be selected from the plurality of orthogonal basis vector sets.

Further, in a specific example, the first projection information matrix may be specifically a first projection coefficient absolute value matrix. In this case, elements in the first projection coefficient absolute value matrix represent absolute values of the projection coefficients after the spatial-domain feature of the first CSI data is projected into the diagonal block matrix.

In a specific example of the solutions of the present disclosure, each first projection information matrix may be processed by using the following scheme, so that L first target elements corresponding to each set are obtained (for example, L maximum value elements are obtained), and then based on the L first target elements corresponding to each set, the target orthogonal basis vector set is determined. Exemplarily, the method further includes:
performing data processing on the elements in the first projection information matrix, to obtain a first vector corresponding to the orthogonal basis vector set, where the first vector is able to represent total relevant information of projection coefficients corresponding to the frequency-domain feature of the first CSI data, for example, represent a sum of the projection coefficients corresponding to the frequency-domain feature of the first CSI data. Exemplarily, taking that the matrix of the first CSI data is WϵC^{Nt×Nsb} as an example, in this case, the first vector is obtained by performing summing on the first projection information matrix by columns and represents the sum of the projection coefficients corresponding to the frequency-domain feature of the first CSI data.

Further, data processing is performed on a part of elements in the first vector and another part of elements in the first vector, to obtain a second vector corresponding to the orthogonal basis vector set, where the second vector is able to represent total relevant information of projection coefficients corresponding to the spatial-domain feature of the first CSI data. For example, taking that the matrix of the first CSI data is WϵC^{Nt×Nsb} as an example, in this case, the second vector is obtained by adding first Nt/2 elements and last Nt/2 elements in the first vector.

Further, the L first target elements corresponding to the orthogonal basis vector set are selected from the second vector. In this way, based on the above scheme, the L first target elements corresponding to each orthogonal basis vector set may be obtained. Here, in order to maximize to extract the communication physical characteristics of the first CSI data, the L first target elements may be specifically L maximum value elements in the second vector.

Further, based on this, the above operation of selecting, from the plurality of orthogonal basis vector sets, the target orthogonal basis vector set whose correlation with the spatial-domain feature of the first CSI data meets the second preset condition based on the first projection information matrix corresponding to each orthogonal basis vector set includes:
selecting, from the plurality of orthogonal basis vector sets, the target orthogonal basis vector set based on the L first target elements corresponding to each orthogonal basis vector set.

For example, the target orthogonal basis vector set is selected from the plurality of orthogonal basis vector sets based on the L maximum value elements corresponding to each orthogonal basis vector set.

Further, in a specific example of the solutions of the present disclosure, the operation of selecting, from the plurality of orthogonal basis vector sets, the target orthogonal basis vector set based on the L first target elements corresponding to each orthogonal basis vector set specifically includes: obtaining a respective target sum corresponding to each orthogonal basis vector set based on the L first target elements corresponding to each orthogonal basis vector set; and then selecting a target value from a plurality of target sums, and taking an orthogonal basis vector set corresponding to the selected target value as the target orthogonal basis vector set. For example, a respective sum of maximum values corresponding to each orthogonal basis vector set is obtained based on the L maximum value elements corresponding to each orthogonal basis vector set; then one sum of maximum values with the largest value is selected from a plurality of sums of maximum values, and a orthogonal basis vector set corresponding to the selected one is taken as the target orthogonal basis vector set.

In an example, after obtaining the target orthogonal basis vector set, the L first target elements in the target orthogonal basis vector set may be directly taken as the L orthogonal basis vectors finally selected. Alternatively, the L orthogonal basis vectors are selected from the target orthogonal basis vector set based on other rules.

It is to be noted that a specific example is provided below to illustrate the operation of obtaining the first basis vector set based on the first DFT vector space constructed by the preset codebook in detail. The details may refer to step a in the following example, which will not be repeated here.

Here, it may be understood that the following example is illustrated by using that the matrix of the first CSI data is WϵC^{Nt×Nsb} as an example. In the actual applications, rows and columns of the matrix of the first CSI data may also be exchanged. In this case, a specific processing method given below only needs to make corresponding data changes based on the principle of matrix multiplication.

In a specific example of the solutions of the present disclosure, data augmentation of the first CSI data may also be jointly implemented based on the first basis vector set and the second basis vector set, in this way, the second CSI data obtained after data augmentation has both spatial-domain feature and frequency-domain feature of the first CSI data. Exemplarily, the method further includes:
determining a second basis vector set representing at least the frequency-domain feature of the first CSI data based on a second DFT vector space constructed by the preset codebook and the first basis vector set representing the spatial-domain feature of the first CSI data.

Based on this, the above operation of performing data augmentation on the first CSI data at least based on the first basis vector set representing the spatial-domain feature of the first CSI data, to obtain the plurality of pieces of second CSI data includes:
performing data augmentation on the first CSI data based on the first basis vector set and the second basis vector set, to obtain the plurality of pieces of second CSI data.

In this way, the second CSI data obtained after data augmentation is performed has both the spatial-domain feature and frequency-domain feature of the original CSI data (that is, the first CSI data).

It is to be noted that the solutions of the present disclosure do not specifically limit the schemes of constructing the second DFT vector space based on the preset codebook. The following specific example provides a method for constructing the second DFT vector space based on eTypeII, which may refer to following description and will not be repeated here. It may be understood that the scheme is only an example and is not intended to limit the solutions of the present disclosure.

Further, in a specific example of the solutions of the present disclosure, the second basis vector set may also be obtained by using the following scheme. Exemplarily, the above operation of determining the second basis vector set representing at least the frequency-domain feature of the first CSI data based on the second DFT vector space constructed by the preset codebook and the first basis vector set representing the spatial-domain feature of the first CSI data specifically includes:
projecting the first CSI data (e.g., the matrix of the first CSI data) into a space spanned by the first basis vector set, to obtain a first projection coefficient matrix; where elements in the first projection coefficient matrix represent projection coefficients of the spatial-domain feature of the first CSI data in the space spanned by the first basis vector set;
selecting, from orthogonal basis vectors included in the second DFT vector space constructed by the preset codebook, M orthogonal basis vectors based on the first projection coefficient matrix, where correlation between the M orthogonal basis vectors and projection coefficients corresponding to the frequency-domain feature of the first CSI data in the first projection coefficient matrix meets a third preset condition (for example, the M orthogonal basis vectors are M vectors that have the highest correlation with the projection coefficients corresponding to the frequency-domain feature of the first CSI data in the first projection coefficient matrix, in the second DFT vector space); M being a natural number greater than or equal to 1; and further,
obtaining the second basis vector set based on the selected M orthogonal basis vectors. That is, the M orthogonal basis vectors constitute a second basis vector set.

It may be understood that magnitude of the correlation may be measured by similarity between vectors. Further, M is a natural number greater than or equal to 1 and less than dimensions of the frequency-domain feature of the first CSI data. For example, in the matrix WϵC^{Nt×Nsb} of the first CSI data, M is a natural number greater than or equal to 1 and less than Nsb.

Further, in an example, average correlation may also be used as an indicator to select the M orthogonal basis vectors from the second DFT vector space. In this case, the M orthogonal basis vectors may also be specifically M vectors selected from the second DFT vector space and have the highest average correlation with the projection coefficients corresponding to the frequency-domain feature of the first CSI data in the first projection coefficient matrix. As such, the M orthogonal basis vectors may better represent the frequency-domain feature of the original CSI data (that is, the first CSI data).

It is to be noted that, in the actual applications, the third preset condition may be set based on actual demand, which is not specifically limited by solutions of the present disclosure.

Further, in a specific example of the solutions of the present disclosure, the first CSI data is projected by using the following scheme. Exemplarily, the above operation of projecting the first CSI data into the space spanned by the first basis vector set specifically includes: projecting the first CSI data into a space spanned by a first basis vector matrix, where the first basis vector matrix is a diagonal block matrix constructed based on the first basis vector set.

In a specific example of the solutions of the present disclosure, the M orthogonal basis vectors may also be obtained by using the following scheme. Exemplarily, the method further includes:
projecting the first projection coefficient matrix into a space spanned by orthogonal basis vectors of the second DFT vector space, to obtain a second projection information matrix; where elements in the second projection information matrix represent relevant information of projection coefficients of the frequency-domain feature of the first CSI data corresponding to the first projection coefficient matrix in the space spanned by the orthogonal basis vectors of the second DFT vector space. In other words, the elements in the second projection information matrix represent the relevant information of the projection coefficients of the frequency-domain feature of the first CSI data in the space spanned by the orthogonal basis vectors of the second DFT vector space.

Further, the above operation of selecting, from the orthogonal basis vectors included in the second DFT vector space constructed by the preset codebook, the M orthogonal basis vectors based on the first projection coefficient matrix may specifically include: selecting, from the orthogonal basis vectors included in the second DFT vector space, the M orthogonal basis vectors based on the second projection information matrix.

In a specific example, the second projection information matrix may be specifically a second projection coefficient absolute value matrix. In this case, elements in the second projection coefficient absolute value matrix represent absolute values of the projection coefficients of the frequency-domain feature of the first CSI data corresponding to the first projection coefficient matrix in the space spanned by the orthogonal basis vectors of the second DFT vector space, that is, the elements in the second projection coefficient absolute value matrix represent the absolute values of the projection coefficients of the frequency-domain feature of the first CSI data in the space spanned by the orthogonal basis vectors of the second DFT vector space.

Further, in a specific example of the solutions of the present disclosure, the operation of selecting, from the orthogonal basis vectors included in the second DFT vector space, the M orthogonal basis vectors based on the second projection information matrix includes:
performing data processing on the elements in the second projection information matrix, to obtain a third vector, where the third vector represents total relevant information of the projection coefficients corresponding to the frequency-domain feature of the first CSI data, for example, represent a sum of the projection coefficients corresponding to the frequency-domain feature of the first CSI data. Exemplarily, taking that the matrix of the first CSI data is WϵC^{Nt×Nsb} as an example, in this time, the third vector is obtained by performing summing on the elements in the second projection coefficient absolute value matrix by columns; and further,
selecting M second target elements from the third vector; and selecting, from the second DFT vector space, orthogonal basis vectors corresponding to the M second target elements, to obtain the M orthogonal basis vectors.

In an example, in order to maximize to extract the communication physical characteristics of the first CSI data, the M second target elements may be specifically M maximum value elements in the third vector. Exemplarily, the first M maximum value elements in the third vector are selected, and then orthogonal basis vectors corresponding to the selected M maximum value elements in the second DFT vector space are taken as the M orthogonal basis vectors finally selected.

It is to be noted that a specific example is provided below to illustrate the operation of obtaining the second basis vector set based on the second DFT vector space constructed by the preset codebook in detail. The details may refer to step b in the following example, which will not be repeated here.

Here, it may be understood that the following example is illustrated by using that the matrix of the first CSI data is WϵC^{Nt×Nsb} as an example. In the actual applications, rows and columns of the matrix of the first CSI data may also be exchanged. In this case, a specific processing method given below only needs to make corresponding data changes based on the principle of matrix multiplication.

In a specific example of the solutions of the present disclosure, after the operation of obtaining the first basis vector set and the second basis vector set, the method further includes:
projecting the first projection coefficient matrix into a space spanned by the second basis vector set, to obtain a second projection coefficient matrix, where elements in the second projection coefficient matrix represent projection coefficients of projection coefficients corresponding to the spatial-domain feature of the first CSI data in the space spanned by the second basis vector set.

Further, the above operation of performing data augmentation on the first CSI data based on the first basis vector set and the second basis vector set, to obtain the plurality of pieces of second CSI data includes:
obtaining the plurality of pieces of second CSI data based on the second projection coefficient matrix, a first basis vector matrix and a second basis vector matrix; where the first basis vector matrix is a matrix formed based on the first basis vector set, and the second basis vector matrix is a matrix formed based on the second basis vector set.

In a specific example, the plurality of pieces of second CSI data are obtained based on a matrix product of the second projection coefficient matrix, the first basis vector matrix and the second basis vector matrix. In this way, data augmentation of the first CSI data may be implemented through the matrix product processing, and this scheme is simple and highly interpretable.

It is to be noted that a specific example is provided below to illustrate the operation of obtaining the second projection coefficient matrix in detail. The details may refer to step c in the following example, which will not be repeated here.

Here, it may be understood that the following example is illustrated by using that the matrix of the first CSI data is WϵC^{Nt×Nsb} as an example. In the actual applications, rows and columns of the matrix of the first CSI data may also be exchanged. In this case, a specific processing method given below only needs to make corresponding data changes based on the principle of matrix multiplication.

In a specific example of the solutions of the present disclosure, after the operation of obtaining the second projection coefficient matrix, scrambling processing may further be performed on the second projection coefficient matrix. Exemplarily, the method further includes:
performing phase adjustment and/or amplitude adjustment on each of the elements in the second projection coefficient matrix, to obtain a plurality of third projection coefficient matrices.

Further, the above operation of obtaining the plurality of pieces of second CSI data based on the second projection coefficient matrix, the first basis vector matrix and the second basis vector matrix specifically includes:
obtaining the plurality of pieces of second CSI data based on the plurality of third projection coefficient matrices, the first basis vector matrix and the second basis vector matrix.

Further, in an example, the above operation of obtaining the plurality of pieces of second CSI data based on the plurality of third projection coefficient matrices, the first basis vector matrix and the second basis vector matrix specifically includes:
obtaining a plurality of vectors to be processed based on a matrix product of the third projection coefficient matrices, the first basis vector matrix and the second basis vector matrix; and performing normalization processing on the plurality of vectors to be processed, to obtain the plurality of pieces of second CSI data.

In a specific example of the solutions of the present disclosure, scrambling processing may be performed on the second projection coefficient matrix by using the following scheme. Exemplarily, the above operation of performing phase adjustment and/or amplitude adjustment on each of the elements in the second projection coefficient matrix specifically includes: taking each of the elements in the second projection coefficient matrix as a center, and adjusting the center in terms of phase and/or amplitude.

That is, the solutions of the present disclosure adopt at least one of the two schemes (such as, only performing phase scrambling, or only performing amplitude adjustment, or performing phase scrambling and amplitude scrambling), so as to perform scrambling processing on the second projection coefficient matrix, to implement data augmentation of the first CSI data.

It is to be noted that a specific example is provided below to illustrate the operation of perform scrambling on the second projection coefficient matrix. The details may refer to step d in the following example, which will not be repeated here.

Here, it may be understood that the following example is illustrated by using that the matrix of the first CSI data is WϵC^{Nt×Nsb} as an example. In the actual applications, rows and columns of the matrix of the first CSI data may also be exchanged. In this case, a specific processing method given below only needs to make corresponding data changes based on the principle of matrix multiplication.

In this way, data augmentation is performed on the real CSI data by means of codebook, to obtain the plurality of pieces of second CSI data. Compared with the existing augmentation schemes for the image data in the computer field, the solutions of the present disclosure fully consider the communication physical characteristics of the real CSI data, and thus, the solutions of the present disclosure are more suitable for data augmentation of the CSI data.

A second data augmentation scheme: data augmentation is performed on the first CSI data, such as the real CSI data, by means of singular value decomposition, and details are as follows.

In a specific example of the solutions of the present disclosure, the method further includes:
obtaining a target autocorrelation matrix of the first CSI data, where the target autocorrelation matrix is able to represent the spatial-domain feature and the frequency-domain feature of the first CSI data; and
performing singular value decomposition on the target autocorrelation matrix, to obtain a singular value decomposition result, where the singular value decomposition result includes a singular vector matrix representing the spatial-domain feature and the frequency-domain feature of the first CSI data and a singular value matrix.

Based on this, the above operation of performing data augmentation on the first CSI data based on the feature information of the first CSI data, to obtain the plurality of pieces of second CSI data includes:
performing, by using a constructed target random matrix, processing on the singular value decomposition result, to obtain the plurality of pieces of second CSI data after data augmentation.

It is to be noted that a specific example is provided below to illustrate the operation of performing processing on the singular value decomposition result by using the constructed target random matrix to obtain the plurality of pieces of second CSI data. The details may refer to steps d and e in the following example, which will not be repeated here.

Here, it may be understood that the following example is illustrated by using that the matrix of the first CSI data is WϵC^{Nt×Nsb} as an example. In the actual applications, rows and columns of the matrix of the first CSI data may also be exchanged. In this case, a specific processing method given below only needs to make corresponding data changes based on the principle of matrix multiplication.

In a specific example of the solutions of the present disclosure, the target autocorrelation matrix may be obtained by using the following method. Exemplarily, the method further includes the following operations.

A first autocorrelation matrix of the first CSI data is obtained, where the first autocorrelation matrix is able to represent the spatial-domain feature of the first CSI data. For example, taking that the matrix of the first CSI data is WϵC^{Nt×Nsb} as an example, in this case, the first autocorrelation matrix R₁ is WW^{H}ϵC^{Nt×Nt} (i.e., R₁=WW^{H}ϵC^{Nt×Nt}), and the first autocorrelation matrix R₁ is able to represent the spatial-domain feature of the first CSI data, such as spatial-domain statistical feature.

A second autocorrelation matrix of the first CSI data is obtained, where the second autocorrelation matrix is able to represent the frequency-domain feature of the first CSI data. For example, continuing to taking that the matrix of the first CSI data is WϵC^{Nt×Nsb} as an example, in this case, the second autocorrelation matrix R₂ is W^{H}WϵC^{Nsb×Nsb} (i.e., R₂=W^{H}WϵC^{Nsb×Nsb}), and the second autocorrelation matrix R₂ is able to represent the frequency-domain feature of the first CSI data, such as frequency-domain statistical feature.

Based on this, the above operation of obtaining the target autocorrelation matrix of the first CSI data specifically includes: obtaining the target autocorrelation matrix based on the first autocorrelation matrix and the second autocorrelation matrix. For example, continuing to taking that the matrix of the first CSI data is WϵC^{Nt×Nsb} as an example, in this case, the target autocorrelation matrix R₃ is R₁⊗R₂ (i.e., R₃=R₁⊗R₂), and the target autocorrelation matrix R₃ is able to represent the spatial-domain feature (such as spatial domain statistical feature) and frequency-domain feature (such as frequency domain statistical feature) of the first CSI data.

In a specific example of the solutions of the present disclosure, the operation of performing processing on the singular value decomposition result by using the target random matrix, to obtain the plurality of pieces of second CSI data after data augmentation specifically includes:
replacing a first matrix in the singular vector matrix by using the target random matrix; and
performing matrix product processing on the target random matrix, a second matrix in the singular vector matrix and the singular value matrix, to obtain the plurality of pieces of second CSI data; where the target autocorrelation matrix is a symmetric matrix, and the first matrix and the second matrix meet a symmetric relationship.

In a specific implementation, the singular value decomposition result may be expressed as: [V, D, U].

Here, VϵC^{NsbNt×NsbNt} and UϵC^{NsbNt×NsbNt} are a left singular vector matrix and a right singular vector matrix, respectively, and a diagonal matrix DϵC^{NsbNt×NsbNt} is a singular value matrix, where diagonal elements are singular values.

As such, the first matrix is the right singular vector matrix in the singular vector matrix, such as UϵC^{NsbNt×NsbNt}; and the second matrix is the left singular vector matrix in the singular vector matrix, such as VϵC^{NsbNt×NsbNt} Based on this, the V=U^{H}.

Further, the operation of performing the matrix product processing on the target random matrix, the second matrix in the singular vector matrix and the singular value matrix, to obtain the plurality of pieces of second CSI data specifically includes:
performing matrix product processing on the target random matrix, the second matrix in the singular vector matrix and the singular value matrix, to obtain an augmented data matrix; and arranging the augmented data matrix based on vector dimensions of the first CSI data, to obtain the plurality of pieces of second CSI data after data augmentation.

Further, the above operation of arranging the augmented data matrix based on the vector dimensions of the first CSI data, to obtain the plurality of pieces of second CSI data after data augmentation specifically includes:
arranging the augmented data matrix based on the vector dimensions of the first CSI data, to obtain an arranged augmented data matrix; and performing normalization processing on the arranged augmented data matrix, to obtain the plurality of pieces of second CSI data.

In this way, data augmentation is performed on the real CSI data by means of singular value decomposition, to obtain the plurality of pieces of second CSI data. Compared with the existing augmentation schemes for the image data in the computer field, the solutions of the present disclosure fully considers the communication physical characteristics of the real CSI data, and thus, which are more suitable for data augmentation of the CSI data.

In this way, the solutions of the present disclosure design a data augmentation method for an AI-based CSI data feedback model, so as to generate a large amount of data using a small amount of the real data whose quantity cannot support model training as a seed. Moreover, compared with the existing augmentation schemes for the image data in the computer field, the solutions of the present disclosure are more suitable for data augmentation of the CSI data.

FIG. 5 is a schematic flowchart of a communication method 500 according to an embodiment of the present disclosure. Optionally, the method may be applied to the system shown in FIG. 1, but is not limited thereto. The method includes at least part of the following contents.

S510, a terminal device transmits first information, where the first information is obtained by inputting channel state information (CSI) data into a first target model for performing encoding processing; and the first target model is obtained by performing model training on a first preset model based on CSI sample data obtained by the above data processing method.

The method for obtaining the CSI sample data in the present embodiment may refer to the relevant description in the above method 400, which will not be repeated here for the sake of brevity.

FIG. 6 is a schematic flowchart of a communication method 600 according to an embodiment of the present disclosure. Optionally, the method may be applied to the system shown in FIG. 1, but is not limited thereto. The method includes at least part of the following contents.

S610, a network device receives first information; and inputs the first information into a second target model for performing decoding processing, to obtain CSI data corresponding to the first information; where the second target model is obtained by performing model training on a second preset model based on CSI sample data obtained by the above data processing method.

The method for obtaining the CSI sample data in the present embodiment may refer to the relevant description in the above method 400, which will not be repeated here for the sake of brevity.

The solutions of the present disclosure are described in detail below with reference to specific examples. Exemplarily, the solutions of the present disclosure is directed at a small amount of the real CSI data (i.e., the first CSI data, hereinafter collectively referred to as real CSI data) to perform data augmentation, that is, a small amount of the real CSI data is taken as a seed, to generate a large amount of data for model training of the AI-based CSI data feedback model, thereby solving the problem that a small amount of the real data cannot support model training.

Exemplarily, the solutions of the present disclosure may implement data augmentation based on the following schemes, and the schemes include: scheme 1, data augmentation is performed on the real CSI data by means of codebook; and scheme 2, data augmentation is performed on the real CSI data by means of singular value decomposition. Compared with the existing augmentation schemes, such as the augmentation schemes for the image data, the solutions of the present disclosure fully consider the communication physical characteristics of the real CSI data, and thus, which are more suitable for data augmentation of the real CSI data in communication scenarios. Moreover, the dataset constructed based on the solutions of the present disclosure is capable of supporting model training, and thus, the data support for improving the accuracy of model training is provided. In addition, since a large amount of data may be generated based on a small amount of real samples according to the solutions of the present disclosure, the corresponding cost of obtaining the real data is greatly reduced, thereby reducing the cost of model training.

The following embodiments involve steps such as high-dimensional vector space projection, which are relatively abstract. For accurate expression, it is considered to adopt a method of mathematical formulas supplemented by corresponding physical explanations for explanation as much as possible.

Example I: data augmentation is performed on real CSI data by means of codebook.

For 5G NR systems, in CSI data feedback design, a codebook-based scheme is mainly used to realize extraction and feedback of channel features. That is, after a transmitting end performs channel estimation, and obtains a corresponding precoding matrix (i.e., the real CSI data) according to channel estimation result, the transmitting end selects a coding matrix that best matches the precoding matrix from preset codebook according to a certain optimization criterion, and feeds back related information such as an index of the coding matrix that best matches the precoding matrix to a receiving end through a feedback link of an air interface, to enable the receiving end to implement precoding. Exemplarily, the codebook may be divided into three schemes: TypeI, TypeII, and eTypeII. The solutions of the present disclosure are illustrated in detail by taking the DFT vector space constructed by eTypeII as an example.

Here, the real CSI data may be represented by a matrix W, that is, the precoding matrix to be fed back by the transmitting end is represented as the matrix WϵC^{Nt×Nsb}, where C represents a complex space, Nt represents the number of ports of transmitting antennas. For example, taking the transmitting antennas at a transmitting end being two-dimensional array antennas as an example, in this case, Nt=2N₁N₂, and N₁ and N₂ represent the number of ports of the two-dimensional array antennas (such as two-dimensional planar array dual-polarized antennas) in a first dimension and a second dimension, respectively. Nsb represents the number of frequency domain sub-bands corresponding to the transmitting end. Further, each column of the matrix W represents a vector for precoding that is shared by a plurality of subcarriers on each frequency domain sub-band. Each row of the matrix W represents a vector corresponding to a port of a transmitting antenna.

First, a first DFT vector space may be constructed by using the following scheme. Exemplarily, generally speaking, the number of orthogonal two-dimensional DFT vectors with a length Nt is at most Nt, which may be expressed as:

$$\begin{matrix}{b}_{m , n} = {c}_{m} ⊗ {p}_{n} , \\ m = 0 , 1 , 2 , … , {N}_{1} - 1 , and \\ n = 0 , 1 , 2 , … , {N}_{2} - 1.\end{matrix}$$

Where b_{m,n} are orthogonal to each other, cₘ and pₙ are one-dimensional DFT vectors, respectively, ⊗ represents the Kroenker product, and expressions for cₘ and pₙ are expressed as follows:

$$\begin{matrix}{c}_{m} = {[ 1 , … , exp ( j 2 π ( {N}_{1} - 1 ) m ) / {N}_{1} ]}^{T} , and \\ {p}_{n} = {[ 1 , … , exp ( j 2 p π ( {N}_{2} - 1 ) m ) / {N}_{2} ]}^{T} .\end{matrix}$$

Here, in order to improve quantization accuracy of codebook and increase a number of basis vectors in the DFT vector space, an oversampling manner may be adopted to increase the number of two-dimensional DFT vectors. For example, oversampling factors of the two-dimensional array antennas in the first dimension and second dimension are set to O₁ and O₂, respectively. In this case, the total number of oversampled two-dimensional DFT vectors may be increased to N₁O₁N₂O₂, which may be expressed as:

$$\begin{matrix}{a}_{m , n} = {v}_{m} ⊗ {u}_{n} , \\ m = 0 , 1 , 2 , … , {N}_{1} {0}_{1} - 1 , and \\ n = 0 , 1 , 2 , … , {N}_{2} {O}_{2} - 1.\end{matrix}$$

Where vₘ and uₙ represent an oversampled one-dimensional DFT vector, respectively, and ⊗ represents the Kronecker product, that is:

$${v}_{m} = {[ 1 , … , exp ( j 2 π ( {N}_{1} - 1 ) m ) / {N}_{1} {O}_{1} ]}^{T} , and \\ {u}_{n} = {[ 1 , … , exp ( j 2 π ( {N}_{2} - 1 ) m ) / {N}_{2} {O}_{2} ]}^{T} .$$

The N₁O₁N₂O₂ DFT vectors, i.e., a_{m,n}, are the first DFT vector space constructed by the solutions of the present disclosure. Further, the first DFT vector space includes O₁O₂ sets, where the first dimension corresponds to O₁ set and the second dimension corresponds to the O₂ set, and there are a total of N₁N₂ DFT vectors in each set and those vectors are pairwise orthogonal. The N₁N₂ vectors in the o1-th (o₁=1, . . . , O₁) set in the first dimension and the o2-th (o₂=1, . . . , O₂) set in the second dimension may be expressed as:

$${a}_{m , n}^{′} = {v}_{m} ⊗ {u}_{n} , m = {o}_{1} - 1 , {O}_{1} + {o}_{1} - 1 , 2 {O}_{1} + {o}_{1} - 1 , … , ( {N}_{1} - 1 ) {O}_{1} + {o}_{1} - 1 , and \\ n = {o}_{2} - 1 , {O}_{2} + {o}_{2} - 1 , 2 {O}_{2} + {o}_{2} - 1 , … , ( {N}_{2} - 1 ) {O}_{2} + {o}_{2} - 1 .$$

Where:

$${v}_{m} = {[ 1 , … , exp ( j 2 π ( {N}_{1} - 1 ) m ) / {N}_{1} {0}_{1} ]}^{T} , and \\ {u}_{n} = {[ 1 , … , exp ( j 2 π ( {N}_{2} - 1 ) m ) / {N}_{2} {O}_{2} ]}^{T} .$$

Secondly, a second DFT vector space may be constructed by using the following scheme. Here, the construction scheme is similar to that described above, and the second DFT vector space may be expressed as:

$${q}_{m} = {[ 1 , … , exp ( j 2 π ( Nsb - 1 ) m ) / Nsb ]}^{T} , m = 0 , 1 , 2 , … , Nsb - 1 .$$

Where the second DFT vector space includes Nsb orthogonal basis vectors with a length of Nsb.

It may be understood that the above schemes for constructing the first DFT vector space and the second DFT vector space are only an exemplary description, which are not intended to limit the solutions of the present disclosure. In the actual applications, there may be other construction schemes, which are not limited by the solutions of the present disclosure.

Further, on a basis of obtaining the first DFT vector space and the second DFT vector space, data augmentation may be performed on the matrix WϵC^{Nt×Nsb} of each piece of the real CSI data (also referred to as a real CSI data sample) by using the following scheme, and the scheme specifically includes following steps.

Step a: one target orthogonal basis vector set Q including N₁N₂ orthogonal basis vectors is selected from the O₁O₂ sets (i.e., O₁O₂ orthogonal basis vector sets) of the first DFT vector space, and L orthogonal basis vectors is selected from the selected target orthogonal basis vector set Q, to obtain a first basis vector set Q′.

Here, the step a may be divided into following sub-steps.

Sub-step a1: one set is selected from the O₁O₂ sets, and a matrix B′ is formed by each element in the set (i.e., the DFT vector a′_{m,n}) by columns, so as to form a diagonal block matrix W′₁=[B′, 0; 0, B′].

For example, take N₁=N₂=O₁=O₂=4 and L=4 as examples, as shown in FIG. 7, each dot (including a solid dot and a hollow dot) represents one vector in the DFT vector space, where the solid dot may be represented as a non-oversampling DFT vector b_{m,n}, and there are 16 non-oversampling DFT vectors in total. The hollow dot represents an oversampled two-dimensional DFT vectors, and there are 15×16 DFT oversampled two-dimensional DFT vectors in total. Based on this, there are a total of N₁O₁N₂O₂=256 two-dimensional DFT vectors a_{m,n} obtained by sampling.

Further, one orthogonal basis vector set is selected from O₁O₂=16 sets, such as wireframes (including dashed frames and solid frames) represent the selected orthogonal basis vector set; and the solid frames represent the L orthogonal basis vectors finally selected.

Sub-step a2: the matrix W of the real CSI data is projected into a space spanned by column vectors of the diagonal block matrix W′₁, to obtain a first projection coefficient absolute value matrix (i.e., the first projection information matrix mentioned-above) W′₂=abs(W′₁^{H}W)ϵR^{Nt×Nsb}. Here, (·)^{H} represents conjugate transpose, and abs(·) represents that matrix elements take absolute values.

Sub-step a3: summing is performed on the first projection coefficient absolute value matrix (i.e., the first projection information matrix) W′₂ by columns, to obtain a first vector w′₂ϵR^{Nt×1}, where R represents a real number space.

Sub-step a4: first Nt/2=N₁N₂ elements and last Nt/2=N₁N₂ elements in the first vector w′₂ are added, to obtain a second vector w″₂ϵR^{Nt/2×1}.

Sub-step a5: arranging is performed on the elements in the second vector w″₂, and indexes corresponding to first L maximum value elements are marked as I={i₁, i₂, . . . , i_{L}}, and a sum of the first L maximum value elements is marked as c.

Sub-step a6: sub-steps a1 to a5 are performed on each of the O₁O₂ sets, to obtain O₁O₂ index sets, recorded as Iₐₗₗ={I₁, I₂, . . . , I_{O}_{₁}_{O}_{₂}}, and obtain sums of first L maximum value elements of each set of the O₁O₂ sets, recorded as C={c₁, c₂, . . . , c_{O}_{₁}_{O}_{₂}}.

Sub-step a7: an index p corresponding to the maximum value C is selected, and the set corresponding to the index p is the target orthogonal basis vector set Q. The target orthogonal basis vector set Q includes N₁N₂ basis vectors.

Sub-step a8: a set Iₚ in Iₐ₁₁ corresponding to the index p is selected, and L orthogonal basis vectors are selected from the target orthogonal basis vector set Q according to indexes included in the set Iₚ, and the L orthogonal basis vectors selected from the target orthogonal basis vector set Q are taken as the first basis vector set Q′.

In the solutions of the present disclosure, each piece of the real CSI data may be represented by a matrix, such as Nsb columns of the matrix WϵC^{Nt×Nsb} are vectors corresponding to Nsb frequency domain sub-bands, and Nt rows are vectors corresponding to Nt transmitting antennas, that is, the rows and columns of the matrix W correspond to spatial-domain feature and frequency-domain feature, respectively.

Further, the step a may be understood as: the L orthogonal basis vectors having the highest average correlation with the vectors corresponding to the Nsb frequency domain sub-bands are found in the first DFT vector space. Exemplarily, firstly, one set having the highest average correlation (that is, the target orthogonal basis vector set) is found from the O₁O₂ orthogonal basis vector sets (corresponding to the sub-steps a1 to a7); and secondly, the L orthogonal basis vectors having the highest average correlation with the vectors corresponding to the Nsb frequency domain sub-bands are found from the found set (that is, the target orthogonal basis vector set) (corresponding to sub-step a8). Since the found L orthogonal basis vectors are basis vectors having the highest correlation, the L orthogonal basis vectors may better represent the spatial-domain feature of the real CSI data.

Step b: M orthogonal basis vectors are selected from the Nsb orthogonal basis vectors of the second DFT vector space, to obtain a second basis vector set P.

Here, the step b is divided into the following sub-steps.

Sub-step b1: a matrix B is formed by performing arranging on elements in the first basis vector set Q′ by columns, and then a first basis vector matrix W₁=[B, 0; 0, B] is formed.

Sub-step b2: the matrix W of the real CSI data is projected into a space spanned by the column vectors of the first basis vector matrix W₁, to obtain a first projection coefficient matrix W₂ₜₑₘₚ=W₁^{H}WϵC^{2L×Nsb}.

Sub-step b3: the first projection coefficient matrix W₂ₜₑₘₚ is projected into the space spanned by Nsb orthogonal basis vectors of the second DFT vector space, to obtain a second projection coefficient absolute value matrix (i.e., the second projection information matrix) W″₂=abs(W′_{f}^{H}W₂ₜₑₘₚ^{T})ϵR^{Nsb×2L}, where W′_{f} is a matrix formed by the Nsb basis vectors of the second DFT vector space arranged in columns, and (·)^{T} represents non-conjugate transpose.

Sub-step b4: summing is performed on elements in the second projection coefficient absolute value matrix W″₂ by columns, to obtain a third vector w′″₂ϵR^{Nsb×1}.

Sub-step b5: indexes corresponding to first M maximum value elements in the third vector w′″₂ are selected and recorded as J={j₁, . . . , j_{M}}, and the M orthogonal basis vectors are selected from the second DFT vector space based on indexes included in J, to obtain the second basis vector set P.

Here, the step b may be understood as: each column in the first projection coefficient matrix W₂ₜₑₘₚ=W₁^{H}WϵC^{2L×Nsb} of the real CSI data on the first basis vector matrix W₁ represents the projection coefficient of the frequency domain sub-band (that is, the spatial-domain feature) corresponding to the real CSI data on the first basis vector matrix W₁, and there still exist the frequency-domain features of the real CSI data between the columns. Further, similar to the step a, the step b is used for finding the M orthogonal basis vectors that have the highest average correlation with the plurality of row vectors of the first projection coefficient matrix W₂ₜₑₘₚ from the second DFT vector space (corresponding to sub-steps b1 to b5). Here, since the found M orthogonal basis vectors are basis vectors having the highest correlation, the M orthogonal basis vectors may better represent the frequency-domain feature of the real CSI data.

Step c: the first projection coefficient matrix W₂ₜₑₘₚ is projected into a space spanned by the M orthogonal basis vectors of the second basis vector set P (that is, the second basis vector matrix), to obtain the second projection coefficient matrix W₂=W_{f}^{H}W₂ₜₑₘₚ^{T}ϵC^{Nsb×2L}, where W_{f} is a second basis vector matrix, that is, a matrix formed by the M orthogonal basis vectors of the second vector set P arranged by columns.

Here, the step c may be understood as: the real CSI data is projected into the space spanned by the found column vectors of the first basis vector matrix and the column vectors of the second basis vector matrix, to obtain the projection coefficients. For example, the matrix W of the real CSI data is left-multiplied by a conjugate transpose of the first basis vector matrix, and then right-multiplied by a conjugate transpose of the second basis vector matrix, to obtain the second projection coefficient matrix.

Step d: scrambling is performed on amplitudes or phases of elements in the second projection coefficient matrix W₂, to obtain a plurality of third projection coefficient matrices W_{2aug}ϵC^{Nsb×2L}. For example, scrambling is performed g times to obtain g third projection coefficient matrices.

Furthermore, scrambling may be performed by using following schemes.

Scheme I: amplitude scrambling, also known as magnitude scrambling. Each element in W₂ is multiplied by a random number λ₁, where λ₁ follows a uniform distribution of U₁˜[1−ε, 1−ε]. In the practical applications, this scheme may resample each element, to obtain a random number λ₁. In this case, each element is multiplied by a different random number λ₁.

Scheme II: phase scrambling. Each element in W₂ is multiplied by a random number λ₂, where λ₂ is sampled from an interval exp(aj), and a follows a uniform distribution of U₂˜[−θ,θ]. In the practical applications, this scheme may resample each element, to obtain a random number λ₂. In this case, each element is multiplied by a different random number λ₂.

It is to be understood that, in the practical applications, the above two schemes may be selected one or the other, to implement scrambling processing, or both schemes may be used to implement scrambling processing together, which are not limited by the solutions of the present disclosure.

Here, the step d may be understood as: by taking each coefficient in the second projection coefficient matrix as a center, scrambling is performed on the center in terms of amplitude dimension or phase dimension. Further, it may be understood as: the second projection coefficient matrix is one point in the space spanned by the column vectors of the first basis vector matrix or the second basis vector matrix. In this case, after amplitude and phase scrambling is performed, the point may be expanded to one sphere.

Step e: each third projection coefficient matrix is multiplied by the first basis vector matrix W₁ and the second basis vector matrix W_{f}, to obtain an non-normalized augmented sample W_{aug,raw}=W₁W_{2aug}^{T}W_{f}^{H}.

Here, the step e may be understood as: a coefficient corresponding to each point in the sphere obtained in the step d is multiplied by the first basis vector matrix and the second basis vector matrix. Since the first basis vector matrix and the second basis vector matrix may better represent the spatial-domain feature and frequency-domain feature of the real CSI data, the step e achieves data augmentation while retaining the spatial-domain feature and frequency-domain feature of the real CSI data.

Step f: normalization is performed on the non-normalized augmented samples W_{aug,raw} according to the frequency domain sub-bands, to obtain final augmented samples W_{aug}=[w_{aug,1}/norm(w_{aug,1}), . . . , w_{aug,Nsb}/norm(w_{aug,Nsb}], where norm(·) represents the 2-norm, and w_{aug,t}, t=1, . . . , Nsb represents different column vectors in W_{aug}.

Therefore, compared with the existing augmentation schemes for image data in the computer field, the solutions of the present disclosure fully consider the communication physical characteristics of the real CSI data, and thus, the solutions of the present disclosure are more suitable for data augmentation of the CSI data.

Further, the sample set for model training may also be constructed by means of codebook in the solutions of the present disclosure, so as to support model training effectively. Here, since a large amount of sample data for model training may be obtained using only a small amount of the real data, the costs of manpower, material and the like for obtaining the real data may be greatly reduced, so that the cost of model training is reduced and the foundation for improving the efficiency and accuracy of model processing is also laid.

Example II: data augmentation is performed by means of singular value decomposition.

The embodiments of the present disclosure further consider that data augmentation is performed by means of singular value decomposition. In general, a singular vector matrix obtained after singular value decomposition is performed on the sample may better represent physical characteristics corresponding to the matrix of the original CSI data. Based on this, using the singular vector matrix as a start point, data augmentation may be achieved while retaining the corresponding physical characteristics. Considering that an existing AI-based CSI data feedback dataset contains K pieces of CSI data (that is, K real CSI data samples), and each piece of the real CSI data is represented as a matrix WϵC^{Nt×Nsb}, where C represents a complex space, and Nt represents the number of ports of transmitting antennas. For example, taking the transmitting antennas at a transmitting end being two-dimensional array antennas, in this case, Nt=2N₁N₂, and N₁ and N₂ represent the number of ports of the two-dimensional array antennas (such as two-dimensional planar array dual-polarized antennas) in a first dimension and a second dimension, respectively. Nsb represents the number of frequency domain sub-bands corresponding to the transmitting end. Further, each column of the matrix W represents a vector for precoding that is shared by a plurality of subcarriers on each frequency domain sub-band. Each row of the matrix W represents a vector corresponding to a port of a transmitting antenna.

Further, for each piece of real CSI data, a data augmentation method by means of singular value decomposition may be specifically divided into following steps.

Step a: a first autocorrelation matrix of the real CSI data R₁=WW^{H}ϵC^{Nt×Nt} is obtained.

Note 8: R₁ retains a spatial-domain statistical feature of a matrix of the original CSI data (i.e., the real CSI data).

Step b: a second autocorrelation matrix of the real CSI data R₂=W^{H}WϵC^{Nsb×Nsb} is obtained.

Note 9: R₂ retains a frequency-domain statistical feature of the matrix of the original CSI data (i.e., the real CSI data).

Step c: a target autocorrelation matrix of the real CSI data R₃=R₁⊗R₂ is obtained, where ⊗ represents the Kronecker product.

Note 10: the target autocorrelation matrix R₃ retains the spatial-domain statistical feature and frequency-domain statistical feature of the matrix of the original CSI data (i.e., the real CSI data).

Step d: singular value decomposition is performed on the target autocorrelation matrix, i.e., [V, D, U]=svd(R₃), where VϵC^{NsbNt×NsbNt} and UϵC^{NsbNt×NsbNt} are a left singular vector matrix and a right singular vector matrix, respectively, and a diagonal matrix DϵC^{NsbNt×NsbNt} is a singular value matrix, where diagonal elements are singular values.

Note 11: V=U^{H} since R₃ is a symmetric matrix. Further, a plurality of singular vectors in V retain the spatial-domain statistical feature and frequency-domain statistical feature of the matrix of the original CSI data (i.e., the real CSI data).

Step e: a target random matrix U′ϵC^{NsbNt×S} is constructed. Here, each element in the target random matrix U′ follows a complex normal distribution, and S represents the number of augmented samples. Further, a augmented sample set matrix (that is, augmented data matrix) W_{aug,all} is obtained:

$${W}_{aug , all} = Vsqrt ( D ) {U}^{′} = [ {w}_{aug , 1}^{′} , {w}_{aug , 2}^{l} , … , {w}_{aug , S}^{′} ] ∈ {C}^{NsbNt \times S} .$$

Where w_{aug,d}′ϵC^{NsbNt×1}(d=1, 2, . . . , S) represents each sample after augmentation (i.e., second CSI data), and sqrt(·) represents to take square root of each element of the matrix.

Note 12: Since augmentation is performed based on the singular vectors in V, the augmented sample still retains the spatial-domain statistical feature and frequency-domain statistical feature of the original CSI data (i.e., the real CSI data).

Step f: elements of each column w_{aug,d}′ϵC^{NsbNt×1}(d=1, 2, . . . , S) in the augmented sample set matrix are rearranged into dimensions of the original CSI data (i.e., the real CSI data), to obtain the augmented samples w_{aug,d}ϵC^{Nt×Nsb} (d=1, 2, . . . , S).

Step g: normalization is performed on non-normalized augmented samples according to the frequency domain sub-bands, to obtain final augmented samples

$${W}_{aug , d} = [ \frac{{w}_{aug , d , 1}}{norm ( {w}_{aug , d , 1} )} , \frac{{w}_{aug , d , 2}}{norm ( {w}_{aug , d , 2} )} , . … , \frac{{w}_{aug , d , Nsb}}{norm ( {w}_{aug , d , Nsb )}} ] ,$$

where norm(·) represents the 2-norm, and w_{aug,d,t}(t=1, 2, . . . , Nsb) represents different column vectors in W_{aug,d}.

Thus, compared with the existing augmentation schemes for image data in the computer field, the solutions of the present disclosure consider the utilization of the communication physical characteristics of the CSI data, so that the solutions of the present disclosure are more suitable for augmentation of the CSI data. Further, the data set constructed by means of singular value decomposition may support model training; and the costs of manpower, material and the like for obtaining the real data are greatly reduced since only a small number of real samples are used.

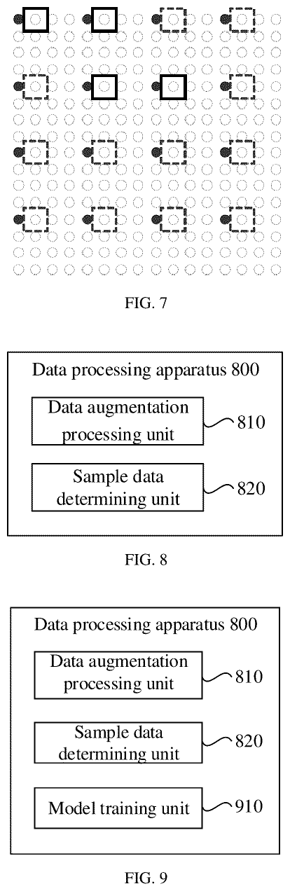

FIG. 8 is a first schematic block diagram of a data processing apparatus 800 according to an embodiment of the present disclosure. The terminal device 800 may include:
a data augmentation processing unit 810, configured to perform data augmentation on first channel state information (CSI) data based on feature information of the first CSI data, to obtain a plurality of pieces of second CSI data; where the feature information include at least one of: a spatial-domain feature or a frequency-domain feature; and
a sample data determining unit 820, configured to take at least the first CSI data and the plurality of pieces of second CSI data as CSI sample data.

In a specific example of the solutions of the present disclosure, the data augmentation processing unit is further configured to:
determine a first basis vector set representing the spatial-domain feature of the first CSI data based on a first discrete Fourier transform (DFT) vector space constructed by a preset codebook; and
perform data augmentation on the first CSI data at least based on the first basis vector set representing the spatial-domain feature of the first CSI data, to obtain the plurality of pieces of second CSI data.

In a specific example of the solutions of the present disclosure, the data augmentation processing unit is specifically configured to:
select L orthogonal basis vectors from orthogonal basis vector sets included in the first DFT vector space, where correlation between the L orthogonal basis vectors and the spatial-domain feature of the first CSI data meets a first preset condition, L being a natural number greater than or equal to 1; and
obtain the first basis vector set based on the selected L orthogonal basis vectors.

In a specific example of the solutions of the present disclosure, the data augmentation processing unit is further configured to:
select, from a plurality of orthogonal basis vector sets included in the first DFT vector space, a target orthogonal basis vector set whose correlation with the spatial-domain feature of the first CSI data meets a second preset condition; and
select the L orthogonal basis vectors from the target orthogonal basis vector set.

In a specific example of the solutions of the present disclosure, the data augmentation processing unit is specifically configured to:
project the first CSI data into a vector space spanned by a diagonal block matrix, to obtain a first projection information matrix corresponding to each orthogonal basis vector set, where the diagonal block matrix is obtained based on the orthogonal basis vector sets included in the first DFT vector space, and elements in the first projection information matrix represent relevant information of projection coefficients after the spatial-domain feature of the first CSI data is projected into the diagonal block matrix; and
select, from the plurality of orthogonal basis vector sets, the target orthogonal basis vector set whose correlation with the spatial-domain feature of the first CSI data meets the second preset condition based on the first projection information matrix corresponding to each orthogonal basis vector set.

In a specific example of the solutions of the present disclosure, the data augmentation processing unit is further configured to:
perform data processing on the elements in the first projection information matrix, to obtain a first vector corresponding to the orthogonal basis vector set, where the first vector is able to represent total relevant information of projection coefficients corresponding to the frequency-domain feature of the first CSI data; and
perform data processing on a part of elements in the first vector and another part of elements in the first vector, to obtain a second vector corresponding to the orthogonal basis vector set, where the second vector is able to represent total relevant information of projection coefficients corresponding to the spatial-domain feature of the first CSI data;
select, from the second vector, L first target elements corresponding to the orthogonal basis vector set; and
select, from the plurality of orthogonal basis vector sets, the target orthogonal basis vector set based on L first target elements corresponding to each orthogonal basis vector set.

In a specific example of the solutions of the present disclosure, the data augmentation processing unit is specifically configured to:
obtain a respective target sum corresponding to each orthogonal basis vector set based on the L first target elements corresponding to each orthogonal basis vector set;
select a target value from a plurality of target sums; and
take an orthogonal basis vector set corresponding to the selected target value as the target orthogonal basis vector set.

In a specific example of the solutions of the present disclosure, the data augmentation processing unit is further configured to:
determine a second basis vector set representing at least the frequency-domain feature of the first CSI data based on a second DFT vector space constructed by the preset codebook and the first basis vector set representing the spatial-domain feature of the first CSI data; and
perform data augmentation on the first CSI data based on the first basis vector set and the second basis vector set, to obtain the plurality of pieces of second CSI data.

In a specific example of the solutions of the present disclosure, the data augmentation processing unit is specifically configured to:
project the first CSI data into a space spanned by the first basis vector set, to obtain a first projection coefficient matrix; where elements in the first projection coefficient matrix represent projection coefficients of the spatial-domain feature of the first CSI data in the space spanned by the first basis vector set;
select, from orthogonal basis vectors included in the second DFT vector space constructed by the preset codebook, M orthogonal basis vectors based on the first projection coefficient matrix, where correlation between the M orthogonal basis vectors and projection coefficients corresponding to the frequency-domain feature of the first CSI data in the first projection coefficient matrix meets a third preset condition, M being a natural number greater than or equal to 1; and
obtain the second basis vector set based on the selected M orthogonal basis vectors.

In a specific example of the solutions of the present disclosure, the data augmentation processing unit is specifically configured to:
project the first CSI data into a space spanned by a first basis vector matrix, where the first basis vector matrix is a diagonal block matrix constructed based on the first basis vector set.

In a specific example of the solutions of the present disclosure, the data augmentation processing unit is further configured to:
project the first projection coefficient matrix into a space spanned by orthogonal basis vectors of the second DFT vector space, to obtain a second projection information matrix; where elements in the second projection information matrix represent relevant information of projection coefficients of the frequency-domain feature of the first CSI data corresponding to the first projection coefficient matrix in the space spanned by the orthogonal basis vectors of the second DFT vector space; and
select, from the orthogonal basis vectors included in the second DFT vector space, the M orthogonal basis vectors based on the second projection information matrix.

In a specific example of the solutions of the present disclosure, the data augmentation processing unit is specifically configured to:
perform data processing on the elements in the second projection information matrix, to obtain a third vector, where the third vector represents total relevant information of the projection coefficients corresponding to the frequency-domain feature of the first CSI data;
select M second target elements from the third vector; and
select, from the second DFT vector space, orthogonal basis vectors corresponding to the M second target elements, to obtain the M orthogonal basis vectors.

In a specific example of the solutions of the present disclosure, the data augmentation processing unit is further configured to:
project the first projection coefficient matrix into a space spanned by the second basis vector set, to obtain a second projection coefficient matrix, where elements in the second projection coefficient matrix represent projection coefficients of projection coefficients corresponding to the spatial-domain feature of the first CSI data in the space spanned by the second basis vector set; and
obtain the plurality of pieces of second CSI data based on the second projection coefficient matrix, a first basis vector matrix and a second basis vector matrix; where the first basis vector matrix is a matrix formed based on the first basis vector set, and the second basis vector matrix is a matrix formed based on the second basis vector set.

In a specific example of the solutions of the present disclosure, the data augmentation processing unit is further configured to:
perform phase adjustment and/or amplitude adjustment on each of the elements in the second projection coefficient matrix, to obtain a plurality of third projection coefficient matrices; and
obtain the plurality of pieces of second CSI data based on the plurality of third projection coefficient matrices, the first basis vector matrix and the second basis vector matrix.

In a specific example of the solutions of the present disclosure, the data augmentation processing unit is specifically configured to:
obtain a plurality of vectors to be processed based on a matrix product of the third projection coefficient matrices, the first basis vector matrix and the second basis vector matrix; and
perform normalization processing on the plurality of vectors to be processed, to obtain the plurality of pieces of second CSI data.

In a specific example of the solutions of the present disclosure, the data augmentation processing unit is specifically configured to:
take each of the elements in the second projection coefficient matrix as a center, and adjusting the center in terms of phase and/or amplitude.

In a specific example of the solutions of the present disclosure, the data augmentation processing unit is further configured to:
obtain a target autocorrelation matrix of the first CSI data, where the target autocorrelation matrix is able to represent the spatial-domain feature and the frequency-domain feature of the first CSI data;
perform singular value decomposition on the target autocorrelation matrix, to obtain a singular value decomposition result, where the singular value decomposition result includes a singular vector matrix representing the spatial-domain feature and the frequency-domain feature of the first CSI data and a singular value matrix; and
perform, by using a constructed target random matrix, processing on the singular value decomposition result, to obtain the plurality of pieces of second CSI data after data augmentation.

In a specific example of the solutions of the present disclosure, the data augmentation processing unit is further configured to:
obtain a first autocorrelation matrix of the first CSI data, where the first autocorrelation matrix is able to represent the spatial-domain feature of the first CSI data;
obtain a second autocorrelation matrix of the first CSI data, where the second autocorrelation matrix is able to represent the frequency-domain feature of the first CSI data; and
obtain the target autocorrelation matrix based on the first autocorrelation matrix and the second autocorrelation matrix.

In a specific example of the solutions of the present disclosure, the data augmentation processing unit is specifically configured to:
replace a first matrix in the singular vector matrix by using the target random matrix; and
perform matrix product processing on the target random matrix, a second matrix in the singular vector matrix and the singular value matrix, to obtain the plurality of pieces of second CSI data; where the target autocorrelation matrix is a symmetric matrix, and the first matrix and the second matrix meet a symmetric relationship.

In a specific example of the solutions of the present disclosure, the data augmentation processing unit is specifically configured to:
perform matrix product processing on the target random matrix, the second matrix in the singular vector matrix and the singular value matrix, to obtain an augmented data matrix; and
arrange the augmented data matrix based on vector dimensions of the first CSI data, to obtain the plurality of pieces of second CSI data after data augmentation.

In a specific example of the solutions of the present disclosure, the data augmentation processing unit is specifically configured to:
arrange the augmented data matrix based on the vector dimensions of the first CSI data, to obtain an arranged augmented data matrix; and
perform normalization processing on the arranged augmented data matrix, to obtain the plurality of pieces of second CSI data.

FIG. 9 is a second schematic block diagram of a data processing device 800 according to an embodiment of the present disclosure. The data processing device 800 may include:
a model training unit 910, configured to perform, based on the CSI sample data, model training on a first preset model, to obtain a first target model, where the first target model is used to preform encoding processing on channel state information (CSI) data to obtain target CSI data; and/or
perform, based on the CSI sample data, model training on a second preset model to obtain a second target model, where the second target model is used to preform decoding processing on target CSI data to obtain CSI corresponding to the target CSI data.

FIG. 10 is a schematic block diagram of a terminal device 1000 according to embodiments of the present disclosure. The terminal device 1000 may include:
a transmitting unit 1010, configured to transmit first information, where the first information is obtained by inputting channel state information (CSI) data into a first target model for performing encoding processing; and the first target model is obtained by performing model training on a first preset model based on CSI sample data obtained by the method mentioned above in the embodiments of the present disclosure.

The terminal device 1000 in the embodiments of the present disclosure may achieve corresponding functions of the terminal device in the above method embodiments. Regarding to processes, functions, implementations and beneficial effects corresponding to each module (sub-module, unit, component or the like) in the terminal device 1000, reference may be made to the corresponding description in the above method embodiments, which will not be repeated here. It is to be noted that the functions described with respect to each module (submodule, unit, component, or the like) in the terminal device 1000 in the embodiments of the present application may be implemented by different modules (submodules, units, components, or the like), or may be implemented by the same module (submodule, unit, component, or the like).

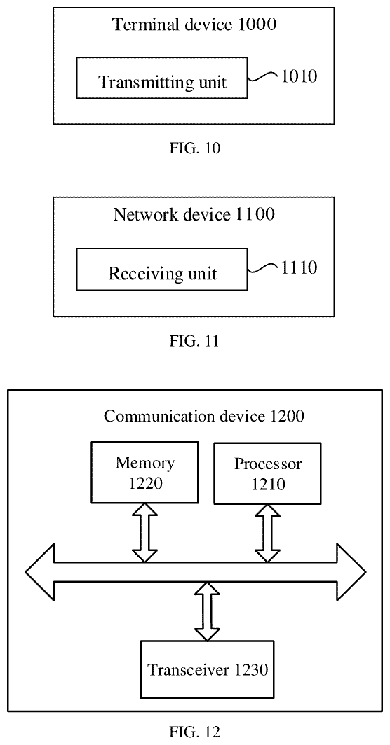

FIG. 11 is a schematic block diagram of a network device 1100 according to embodiments of the present disclosure. The network device 1100 may include:
a receiving unit 1110, configured to receive first information, and input the first information into a second target model for performing decoding processing, to target obtain CSI data corresponding to the first information; where the second target model is obtained by performing model training on a second preset model based on CSI sample data obtained by the method in the embodiment of the present disclosure.

The network device 1100 in the embodiments of the present application may achieve corresponding functions of the network device in the above method embodiments. Regarding to processes, functions, implementations and beneficial effects corresponding to each module (sub-module, unit, component or the like) in the network device 1100, reference may be made to the corresponding description in the above method embodiments, which will not be repeated here. It is to be noted that the functions described with respect to each module (submodule, unit, component, or the like) in the network device 1100 in the embodiments of the present application may be implemented by different modules (submodules, units, components, or the like), or may be implemented by the same module (submodule, unit, component, or the like).

FIG. 12 is a schematic structural diagram of a communication device 1200 according to embodiments of the present disclosure. The communication device 1200 includes a processor 1210, and the processor 1210 may call a computer program from a memory and run the computer program, to cause the communication device 1200 to implement the methods in the embodiments of the present disclosure.

In an implementation, the communication device 1200 may further include a memory 1220. The processor 1210 may call a computer program from the memory 1220 and run the computer program, to cause the communication device 1200 to implement the methods in the embodiments of the present disclosure.

The memory 1220 may be a separate device independent from the processor 1210, or may be integrated into the processor 1210.

In an implementation, the communication device 1200 may further include a transceiver 1230, and the processor 1210 may control the transceiver 1230 to communicate with other devices, and specifically, to transmit information or data to other devices, or receive information or data transmitted by the other devices.

The transceiver 1230 may include a transmitter and a receiver. The transceiver 1230 may further include antenna(s), and there may be one or more antennas.

In an implementation, the communication device 1200 may be the network device of the embodiments of the present disclosure, and the communication device 1200 may implement the corresponding processes implemented by the network device in various methods of the embodiments of the present disclosure, which will not be repeated here for the sake of brevity.

In an implementation, the communication device 1200 may be the terminal device of the embodiments of the present disclosure, and the communication device 1200 may implement the corresponding processes implemented by the terminal device in various methods of the embodiments of the present disclosure, which will not be repeated here for the sake of brevity.

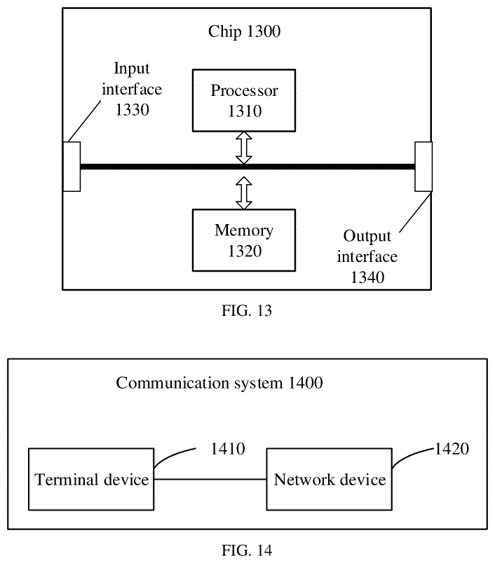

FIG. 13 is a schematic structural diagram of a chip 1300 according to the embodiments of the present disclosure. The chip 1300 includes a processor 1310, and the processor 1310 may call a computer program from a memory and run the computer program to implement the methods in the embodiments of the present disclosure.

In an implementation, the chip 1300 may further include a memory 1320. The processor 1310 may call a computer program from the memory 1320 and run the computer program to implement the methods implemented by the terminal device or the network device in the embodiment of the present disclosure.

The memory 1320 may be a separate device independent from the processor 1310 or may be integrated into the processor 1310.

In an implementation, the chip 1300 may further include an input interface 1330. The processor 1310 may control the input interface 1330 to communicate with other devices or chips, and specifically, may obtain information or data transmitted by other devices or chips.

In an implementation, the chip 1300 may further include an output interface 1340. The processor 1310 may control the output interface 1340 to communicate with other devices or chips, and specifically, may output information or data to other devices or chips.

In an implementation, the chip may be applied to the network device in the embodiments of the present application, and the chip may implement the corresponding processes implemented by the network device in the various methods in the embodiments of the present application, which will not be repeated here for the sake of brevity.

In an implementation, the chip may be applied to the terminal device in the embodiments of the present application, and the chip may implement the corresponding processes implemented by the terminal device in the various methods in the embodiments of the present application, which will not be repeated here for the sake of brevity.

The chips applied to the network device and the terminal device may be the same chips or different chips.

It should be understood that, the chip mentioned in the embodiments of the present application may also be referred to as a system-level chip, a system chip, a chip system or a system-on-chip.

The processor mentioned above may be a general-purpose processor, a digital signal processor (DSP), a field programmable gate array (FPGA), an application specific integrated circuit (ASIC) or another programmable logic device, a transistor logic device, or a discrete hardware component. The general-purpose processor mentioned above may be a microprocessor or any conventional processor.

The memory mentioned above may be a volatile (transitory) memory or a non-volatile (non-transitory) memory, or may include both the volatile memory and the non-volatile memory. Here, the non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or flash memory. The volatile memory may be a random access memory (RAM).

It is to be understood that the above memory is exemplary but not limited illustration. For example, the memory in the embodiments of the present application may also be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct rambus random access memory (Direct Rambus RAM, DR RAM), or the like. That is, the memories in the embodiments of the present application are intended to include, but not limited to, these and any other suitable types of memories.

FIG. 14 is a schematic block diagram of a communication system 1400 according to the embodiments of the present disclosure. The communication system 1400 includes a terminal device 1410 and a network device 1420.

The terminal device 1410 transmits first information, where the information is obtained by inputting channel state information (CSI) data into a first target model for performing encoding processing; and the first target model is obtained by performing model training on a first preset model based on CSI sample data obtained by the above method.

The network device 1420 receives first information, and inputs the first information into a second target model for performing decoding processing, to obtain CSI data corresponding to the first information; where the second target model is obtained by performing model training on a second preset model based on CSI sample data obtained by the above method.

The terminal device 1410 may be used to implement corresponding functions implemented by the terminal device in the above methods, and the network device 1420 may be used to implement corresponding functions implemented by the network device in the above methods, which will not be repeated here for the sake of brevity.

In the above embodiments, all or part of them may be implemented by software, hardware, firmware or any combination thereof. When implemented using software, all or part of the above embodiments may be implemented in a form of a computer program product. The computer program product includes one or more computer instructions. When the computer program instruction(s) are loaded and run on a computer, the processes or functions described in the embodiments of the present application are generated in whole or in part. The computer may be a general-purpose computer, a special purpose computer, a computer network, or any other programmable device. The computer instruction(s) may be stored in a computer-readable storage medium, or transmitted from a computer-readable storage medium to another computer-readable storage medium. For example, the computer instruction(s) may be transmitted from a website, computer, server, or data center to another website, computer, server, or data center via a wired manner (e.g., coaxial cable, optical fiber, or digital subscriber line (DSL)) or a wireless manner (e.g., infrared, wireless, or microwave). The computer-readable storage medium may be any available medium that can be read by a computer or a data storage device such as a server or a data center that includes one or more available medium. The available medium may be a magnetic medium (e.g., a floppy disk, hard disk, or magnetic tape), an optical medium (e.g., a digital video disc (DVD)), or a semiconductor medium (e.g., a solid state disk (SSD)).

It should be understood that, in the various embodiments of the present application, the magnitude of the serial numbers of the above processes does not mean the execution order. The execution order of the processes should be determined by their functions and internal logic, and should not constitute any limitation on the implementation process of the embodiments of the present application.

Those skilled in the art may clearly understand that, for convenience and conciseness of description, the specific working processes of the system, devices and modules described above may refer to the corresponding processes in the above method embodiments, which will not be repeated here.

The foregoing descriptions are merely specific implementations of the present application, but the protection scope of the present application is not limited thereto. Any person skilled in the art may readily conceive of variations or substitutions within the technical scope disclosed in the present application, which should be included within the protection scope of the present application. Therefore, the protection scope of the present application shall be subject to the protection scope of the claims.

What is claimed is:

1. A data processing method, comprising:
performing data augmentation on first channel state information (CSI) data based on feature information of the first CSI data, to obtain a plurality of pieces of second CSI data; wherein the feature information comprises at least one of: a spatial-domain feature or a frequency-domain feature; and
taking at least the first CSI data and the plurality of pieces of second CSI data as CSI sample data.

2. The method of claim 1, further comprising:
determining a first basis vector set representing the spatial-domain feature of the first CSI data based on a first discrete Fourier transform (DFT) vector space constructed by a preset codebook;
wherein performing data augmentation on the first CSI data based on the feature information of the first CSI data, to obtain the plurality of pieces of second CSI data comprises:
performing data augmentation on the first CSI data at least based on the first basis vector set representing the spatial-domain feature of the first CSI data, to obtain the plurality of pieces of second CSI data.

3. The method of claim 2, wherein determining the first basis vector set representing the spatial-domain feature of the first CSI data based on the first DFT vector space constructed by the preset codebook comprises:
selecting L orthogonal basis vectors from orthogonal basis vector sets comprised in the first DFT vector space, wherein correlation between the L orthogonal basis vectors and the spatial-domain feature of the first CSI data meets a first preset condition, L being a natural number greater than or equal to 1; and
obtaining the first basis vector set based on the selected L orthogonal basis vectors.

4. The method of claim 3, further comprising:
selecting, from a plurality of orthogonal basis vector sets comprised in the first DFT vector space, a target orthogonal basis vector set whose correlation with the spatial-domain feature of the first CSI data meets a second preset condition;
wherein selecting the L orthogonal basis vectors from the orthogonal basis vector set comprised in the first DFT vector space comprises:
selecting the L orthogonal basis vectors from the target orthogonal basis vector set.

5. The method of claim 2, further comprising:
determining a second basis vector set representing at least the frequency-domain feature of the first CSI data based on a second DFT vector space constructed by the preset codebook and the first basis vector set representing the spatial-domain feature of the first CSI data;
wherein performing data augmentation on the first CSI data at least based on the first basis vector set representing the spatial-domain feature of the first CSI data, to obtain the plurality of pieces of second CSI data comprises:
performing data augmentation on the first CSI data based on the first basis vector set and the second basis vector set, to obtain the plurality of pieces of second CSI data.

6. The method of claim 5, wherein determining the second basis vector set representing at least the frequency-domain feature of the first CSI data based on the second DFT vector space constructed by the preset codebook and the first basis vector set representing the spatial-domain feature of the first CSI data comprises:
projecting the first CSI data into a space spanned by the first basis vector set, to obtain a first projection coefficient matrix; wherein elements in the first projection coefficient matrix represent projection coefficients of the spatial-domain feature of the first CSI data in the space spanned by the first basis vector set;
selecting, from orthogonal basis vectors comprised in the second DFT vector space constructed by the preset codebook, M orthogonal basis vectors based on the first projection coefficient matrix, wherein correlation between the M orthogonal basis vectors and projection coefficients corresponding to the frequency-domain feature of the first CSI data in the first projection coefficient matrix meets a third preset condition, M being a natural number greater than or equal to 1; and
obtaining the second basis vector set based on the selected M orthogonal basis vectors.

7. The method of claim 6, further comprising:
projecting the first projection coefficient matrix into a space spanned by orthogonal basis vectors of the second DFT vector space, to obtain a second projection information matrix; wherein elements in the second projection information matrix represent relevant information of projection coefficients of the frequency-domain feature of the first CSI data corresponding to the first projection coefficient matrix in the space spanned by the orthogonal basis vectors of the second DFT vector space;
wherein selecting, from the orthogonal basis vectors comprised in the second DFT vector space constructed by the preset codebook, the M orthogonal basis vectors based on the first projection coefficient matrix comprises:
selecting, from the orthogonal basis vectors comprised in the second DFT vector space, the M orthogonal basis vectors based on the second projection information matrix.

8. The method of claim 7, wherein selecting, from the orthogonal basis vectors comprised in the second DFT vector space, the M orthogonal basis vectors based on the second projection information matrix comprises:
performing data processing on the elements in the second projection information matrix, to obtain a third vector, wherein the third vector represents total relevant information of the projection coefficients corresponding to the frequency-domain feature of the first CSI data;
selecting M second target elements from the third vector; and
selecting, from the second DFT vector space, orthogonal basis vectors corresponding to the M second target elements, to obtain the M orthogonal basis vectors.

9. The method of claim 6, further comprising:
projecting the first projection coefficient matrix into a space spanned by the second basis vector set, to obtain a second projection coefficient matrix, wherein elements in the second projection coefficient matrix represent projection coefficients of the projection coefficients of the spatial-domain feature of the first CSI data in the space spanned by the first basis vector set, in the space spanned by the second basis vector set;
wherein performing data augmentation on the first CSI data based on the first basis vector set and the second basis vector set, to obtain the plurality of pieces of second CSI data comprises:
obtaining the plurality of pieces of second CSI data based on the second projection coefficient matrix, a first basis vector matrix and a second basis vector matrix; wherein the first basis vector matrix is a matrix formed based on the first basis vector set, and the second basis vector matrix is a matrix formed based on the second basis vector set.

10. The method of claim 9, further comprising:
performing phase adjustment and/or amplitude adjustment on each of the elements in the second projection coefficient matrix, to obtain a plurality of third projection coefficient matrices;
wherein obtaining the plurality of pieces of second CSI data based on the second projection coefficient matrix, the first basis vector matrix and the second basis vector matrix comprises:
obtaining the plurality of pieces of second CSI data based on the plurality of third projection coefficient matrices, the first basis vector matrix and the second basis vector matrix.

11. The method of claim 10, wherein obtaining the plurality of pieces of second CSI data based on the plurality of third projection coefficient matrices, the first basis vector matrix and the second basis vector matrix comprises:
obtaining a plurality of vectors to be processed based on a matrix product of the third projection coefficient matrices, the first basis vector matrix and the second basis vector matrix; and
performing normalization processing on the plurality of vectors to be processed, to obtain the plurality of pieces of second CSI data.

12. The method of claim 10, wherein performing phase adjustment and/or amplitude adjustment on each of the elements in the second projection coefficient matrix comprises:
taking each of the elements in the second projection coefficient matrix as a center, and adjusting the center in terms of phase and/or amplitude.

13. The method of claim 1, further comprising:
obtaining a target autocorrelation matrix of the first CSI data, wherein the target autocorrelation matrix represents the spatial-domain feature and the frequency-domain feature of the first CSI data; and
performing singular value decomposition on the target autocorrelation matrix, to obtain a singular value decomposition result, wherein the singular value decomposition result comprises a singular vector matrix representing the spatial-domain feature and the frequency-domain feature of the first CSI data and a singular value matrix;
wherein performing data augmentation on the first CSI data based on the feature information of the first CSI data, to obtain the plurality of pieces of second CSI data comprises:
performing, by using a constructed target random matrix, processing on the singular value decomposition result, to obtain the plurality of pieces of second CSI data after data augmentation.

14. The method of claim 13, further comprising:
obtaining a first autocorrelation matrix of the first CSI data, wherein the first autocorrelation matrix represents the spatial-domain feature of the first CSI data; and
obtaining a second autocorrelation matrix of the first CSI data, wherein the second autocorrelation matrix represents the frequency-domain feature of the first CSI data;
wherein obtaining the target autocorrelation matrix of the first CSI data comprises:
obtaining the target autocorrelation matrix based on the first autocorrelation matrix and the second autocorrelation matrix.

15. The method of claim 13, wherein performing, by using the target random matrix, processing on the singular value decomposition result, to obtain the plurality of pieces of second CSI data after data augmentation comprises:
replacing a first matrix in the singular vector matrix by using the target random matrix; and
performing matrix product processing on the target random matrix, a second matrix in the singular vector matrix and the singular value matrix, to obtain the plurality of pieces of second CSI data; wherein the target autocorrelation matrix is a symmetric matrix, and the first matrix and the second matrix meet a symmetric relationship.

16. The method of claim 15, wherein performing the matrix product processing on the target random matrix, the second matrix in the singular vector matrix and the singular value matrix, to obtain the plurality of pieces of second CSI data comprises:
performing matrix product processing on the target random matrix, the second matrix in the singular vector matrix and the singular value matrix, to obtain an augmented data matrix; and
arranging the augmented data matrix based on vector dimensions of the first CSI data, to obtain the plurality of pieces of second CSI data after data augmentation.

17. The method of claim 16, wherein arranging the augmented data matrix based on the vector dimensions of the first CSI data, to obtain the plurality of pieces of second CSI data after data augmentation comprises:
arranging the augmented data matrix based on the vector dimensions of the first CSI data, to obtain an arranged augmented data matrix; and
performing normalization processing on the arranged augmented data matrix, to obtain the plurality of pieces of second CSI data.

18. The method of claim 1, further comprising:
performing, based on the CSI sample data, model training on a first preset model, to obtain a first target model, wherein the first target model is used to preform encoding processing on CSI data to obtain target CSI data; and/or
performing, based on the CSI sample data, model training on a second preset model, to obtain a second target model, wherein the second target model is used to preform decoding processing on the target CSI data to obtain CSI corresponding to the target CSI data.

19. A terminal device, comprising: a processor and a memory, wherein the memory is configured to store a computer program, and the processor is configured to call the computer program stored in the memory and run the computer program, to cause the terminal device to perform:
transmitting first information, wherein the first information is obtained by inputting channel state information (CSI) data into a first target model for performing encoding processing; the first target model is obtained by performing model training on a first preset model based on CSI sample data, and the CSI sample data is obtained according to the following steps:
performing data augmentation on first CSI data based on feature information of the first CSI data, to obtain a plurality of pieces of second CSI data; wherein the feature information comprises at least one of: a spatial-domain feature or a frequency-domain feature; and
taking at least the first CSI data and the plurality of pieces of second CSI data as the CSI sample data.

20. A network device, comprising: a processor and a memory, wherein the memory is configured to store a computer program, and the processor is configured to call the computer program stored in the memory and run the computer program, to cause the network device to perform:
receiving first information; and
inputting the first information into a second target model for performing decoding processing, to obtain CSI data corresponding to the first information; wherein the second target model is obtained by performing model training on a second preset model based on CSI sample data, and the CSI sample data is obtained according to the following steps:
performing data augmentation on first CSI data based on feature information of the first CSI data, to obtain a plurality of pieces of second CSI data; wherein the feature information comprises at least one of: a spatial-domain feature or a frequency-domain feature; and
taking at least the first CSI data and the plurality of pieces of second CSI data as the CSI sample data.
